(19) United States
(12) Patent Application Publication
(10) Pub. No.: US 2026/0304463 A1
(43) Pub. Date: Oct. 1, 2026

(54) COMMUNICATION METHOD, APPARATUS, DEVICE AND SYSTEM, AND STORAGE MEDIUM

(71) Applicant: Beijing Xiaomi Mobile Software Co., Ltd., Beijing (CN)

(72) Inventor: Xuemei QIAO, Beijing (CN)

(73) Assignee: Beijing Xiaomi Mobile Software Co., Ltd., Beijing (CN)

(21) Appl. No.: 19/489,055

(22) PCT Filed: Jun. 2, 2023
(86) PCT No.: PCT/CN2023/098166

§ 371 Date: Dec. 1, 2025

(51) Int. Cl. H04W 72/51; H04L 5/00; H04W 72/566

(52) U.S. Cl. CPC H04W 72/51; H04L 5/0094; H04W 72/566

(57) ABSTRACT

A communication method is performed by a terminal. The method includes determining indication information configured to indicate at least one of an association relationship between first information and a terminal type, or an association relationship between the first information and the terminal. The first information is configured to schedule a downlink channel. The terminal type includes at least one of a type 1 terminal or a type 2 terminal, and a capability of the type 1 terminal is different from a capability of the type 2 terminal. The capability of the type 1 terminal is higher than the capability of the type 2 terminal, or the capability of the type 2 terminal is higher than the capability of the type 1 terminal.

### CROSS REFERENCE TO RELATED APPLICATION

The present application is a U.S. National Stage of International Application No. PCT/CN2023/098166, filed on Jun. 2, 2023, the entire contents of which are incorporated herein by reference.

### BACKGROUND OF THE INVENTION

In a communication system, a Reduced Capability (Redcap) terminal (or an enhanced Redcap (eRedCap) terminal) is extensively applied due to low complexity and low cost. While achieving low complexity and low cost, a baseband bandwidth of the Redcap terminal (or the eRedCap terminal) is also reduced.

### SUMMARY OF THE INVENTION

According to a first aspect of the embodiments of the present disclosure, a communication method is provided. The communication method includes: determining indication information, where the indication information is configured to indicate at least one of an association relationship between first information and a terminal type, or an association relationship between the first information and a terminal, and the first information is configured to schedule a downlink channel. The terminal type includes at least one of a type 1 terminal or a type 2 terminal, and a capability of the type 1 terminal is different from a capability of the type 2 terminal. The capability of the type 1 terminal is higher than the capability of the type 2 terminal, or the capability of the type 2 terminal is higher than the capability of the type 1 terminal.

According to a second aspect of the embodiments of the present disclosure, a communication method is provided. The communication method includes: configuring indication information for a terminal, where the indication information is configured to indicate at least one of an association relationship between first information and a terminal type, or an association relationship between the first information and the terminal, and the first information is configured to schedule a downlink channel. The terminal type includes at least one of a type 1 terminal or a type 2 terminal, and a capability of the type 1 terminal is different from a capability of the type 2 terminal. The capability of the type 1 terminal is higher than the capability of the type 2 terminal, or the capability of the type 2 terminal is higher than the capability of the type 1 terminal.

According to a third aspect of the embodiments of the present disclosure, a terminal is provided. The terminal includes a processor and a memory. The memory is configured to store a computer program, and the processor is configured to execute the computer program to: determine indication information, where the indication information is configured to indicate at least one of an association relationship between first information and a terminal type, or an association relationship between the first information and a terminal, and the first information is configured to schedule a downlink channel. The terminal type includes at least one of a type 1 terminal or a type 2 terminal, and a capability of the type 1 terminal is different from a capability of the type 2 terminal. The capability of the type 1 terminal is higher than the capability of the type 2 terminal, or the capability of the type 2 terminal is higher than the capability of the type 1 terminal.

According to a fourth aspect of the embodiments of the present disclosure, a network device is provided. The terminal includes a processor and a memory. The memory is configured to store a computer program, and the processor is configured to execute the computer program to perform the communication method in the second aspect.

### BRIEF DESCRIPTION OF DRAWINGS

At least one of the above or additional aspects and advantages of the present disclosure becomes apparent and easy to understand from the following descriptions of the embodiments in combination with the accompanying drawings.

FIG. 1 is a schematic diagram of an architecture of some communication systems provided by the embodiments of the present disclosure.

FIG. 2A to FIG. 2D are schematic diagrams of the interaction of a communication method provided by an embodiment of the present disclosure.

FIG. 3A to FIG. 3E are schematic flowcharts of a communication method provided by another embodiment of the present disclosure.

FIG. 4A to FIG. 4E are schematic flowcharts of a communication method provided by yet another embodiment of the present disclosure.

FIG. 5 is a schematic flowchart of a communication method provided by still another embodiment of the present disclosure.

FIG. 6A is a schematic diagram of a structure of a first communication device provided by an embodiment of the present disclosure.

FIG. 6B is a schematic diagram of a structure of a first communication device provided by an embodiment of the present disclosure.

FIG. 7A is a schematic diagram of a structure of a communication device provided by an embodiment of the present disclosure.

FIG. 7B is a schematic diagram of a structure of a chip provided by an embodiment of the present disclosure.

### DETAILED DESCRIPTION OF THE INVENTION

The method in the present disclosure may be used to solve the technical problem of “how to reduce power consumption of a terminal”.

The embodiments of the present disclosure provide a communication method and device, a communication device, a communication system, and a storage medium.

In a first aspect, an embodiment of the present disclosure provides a communication method. The communication method includes: determining indication information, where the indication information is configured to indicate at least one of an association relationship between first information and a terminal type, or an association relationship between the first information and a terminal, and the first information is configured to schedule a downlink channel.

In the above embodiment, the terminal may determine the indication information. The indication information is configured to indicate at least one of: the association relationship between the first information and the terminal type, or the association relationship between the first information and the terminal. First information having an association relationship with a terminal type is information to be sent to such type of terminal, and first information having an association relationship with a terminal is information to be sent to the terminal. As can be seen, in the embodiments of the present disclosure, each type of terminal may determine, based on the indication information, whether the first information is sent to the terminal itself or whether the first information is sent to the terminal type to which the terminal itself belongs, and does not need to read the first information. In a case where the terminal determines that the first information is not sent to the terminal itself or the first information is not sent to the terminal type to which the terminal itself belongs, the terminal may not read the first information, or not receive a channel scheduled by the first information any more, or not read the channel scheduled by the first information. Thus, unnecessary reception and reading by the terminal may be avoided. Power consumption of the terminal is saved, and communication efficiency is improved.

In combination with some embodiments in the first aspect, in some embodiments, the terminal type includes at least one of a type 1 terminal or a type 2 terminal. A capability of the type 1 terminal is different from a capability of the type 2 terminal.

In combination with some embodiments in the first aspect, in some embodiments, determining the indication information includes at least one of: determining a first resource, where the first resource is configured to transmit the first information, and a first resource corresponding to the type 1 terminal is different from a first resource corresponding to the type 2 terminal; determining a first identifier, where the first identifier is configured to descramble the first information, and a first identifier corresponding to the type 1 terminal is different from a first identifier corresponding to the type 2 terminal; determining a reference signal resource, where the reference signal resource is used for a channel estimation of a first channel, the first channel is configured to carry the first information, and a reference signal resource corresponding to the type 1 terminal is different from a reference signal resource corresponding to the type 2 terminal; or determining a first indication carried in received first information, where the first indication is configured to indicate that the first information is sent to the type 1 terminal or the type 2 terminal.

In the above embodiments, the type 1 terminal or the type 2 terminal may respectively determine the first resource. The first resource is configured to transmit the first information. The first resource corresponding to the type 1 terminal is different from the first resource corresponding to the type 2 terminal. The first resource corresponding to the type 1 terminal is different from the first resource corresponding to the type 2 terminal, such that the first resource for transmitting the type 1 terminal is distinguished from the first resource for transmitting the type 2 terminal. Thus, when the network device is about to send the first information to each type of terminal, the network device may send the first information to the type of terminal on the first resource corresponding to the type of terminal. In this way, the type 1 terminal may receive the first information for the type 1 terminal on the first resource corresponding to the type 1 terminal, and the type 2 terminal may receive the first information for the type 2 terminal on the first resource corresponding to the type 2 terminal. Each type of terminal may clearly know on which resource the first information for the terminal itself is received, such that unnecessary blind detection by the terminal may be avoided, and the power consumption of the terminal may be saved.

Moreover, since the first information of each type of terminal is transmitted using different resources, a situation where “first information received by a type of terminal is not sent to such type of terminal itself” cannot occur. Thus, unnecessary reading of the first information by the terminal may be avoided, the power consumption of the terminal is further saved, and communication efficiency is improved.

In the above embodiments, the type 1 terminal or the type 2 terminal may respectively determine the first identifier of the first information. The first identifier is configured to descramble the first information. The first identifier corresponding to the type 1 terminal is different from the first identifier corresponding to the type 2 terminal. The first identifier corresponding to the type 1 terminal is different from the first identifier corresponding to the type 2 terminal, such that the first information of different types of terminals is distinguished from each other. Thus, when the network device is about to send the first information to each type of terminal, the first information sent to the type of terminal may be scrambled by the first identifier corresponding to the type of terminal. Moreover, after the type of terminal receives the first information, the first information may be first descrambled based on the respective first identifier. In a case where descrambling succeeds, it indicates that the first information is sent to the terminal itself. In a case where the descrambling fails, it indicates that the first information is not sent to the terminal itself. As can be seen, in the embodiments of the present disclosure, the terminal may determine whether the first information is sent to the terminal itself by determining whether the terminal may successfully descramble the first information, and does not need to read the first information. Thus, unnecessary reading of the first information by the terminal is avoided. Moreover, in a case where it is determined that the first information is not sent to the terminal itself, the terminal subsequently does not need to receive the second channel (such as a Physical Downlink Shared Channel (PDSCH)) scheduled by the first information. Thus, unnecessary reception and processing of the second channel by the terminal are also avoided, the power consumption of the terminal is saved, and communication efficiency is improved.

In the above embodiments, the type 1 terminal or the type 2 terminal may respectively determine the reference signal resource corresponding to the first information. The reference signal resource is used for the channel estimation of the first channel, and the first channel is configured to carry the first information. The reference signal resource corresponding to the type 1 terminal is different from the reference signal resource corresponding to the type 2 terminal. The reference signal resource corresponding to the type 1 terminal is different from the reference signal resource corresponding to the type 2 terminal, such that the reference signal resources of different types of terminals are distinguished from each other. Thus, when the network device is about to send the first information to each type of terminal, the network device may send the first information to the type of terminal based on the reference signal resource corresponding to the type of terminal. After the type of terminal receives the first information, whether the first information is transmitted to the terminal itself may be determined based on the reference signal resource corresponding to the terminal itself. For example, the terminal may first determine a reference signal sequence or extract a signal from the first channel based on the reference signal resource corresponding to the terminal itself, and determine whether a correlation peak may be generated between the reference signal sequence or the extracted signal and the original reference signal sequence. In a case where the correlation peak is generated, it is determined that the first information is transmitted to the terminal itself. In a case where no correlation peak is generated, it is determined that the first information is not sent to the terminal itself. As can be seen, in the embodiments of the present disclosure, the terminal may determine, by determining the reference signal of the first channel, whether the first information carried by the first channel is sent to the terminal itself, instead of directly reading the first information. Thus, unnecessary decoding of the first information by the terminal may be avoided. Moreover, in a case where it is determined that the first information is not sent to the terminal itself, the terminal subsequently does not need to receive the second channel (such as a PDSCH) scheduled by the first information. Thus, unnecessary reception and processing of the second channel by the terminal are also avoided, power consumption of the terminal is saved, and communication efficiency is improved.

In the above embodiments, the type 1 terminal or the type 2 terminal may respectively receive the first information. The first indication is carried in the first information, and the first indication is configured to indicate that the first information is sent to the type 1 terminal or the type 2 terminal. Since the first indication is carried in the first information, after each type of terminal receives the first information, whether the first information is sent to the terminal itself may be determined based on the first indication in the first information. In a case where it is determined that the first information is not sent to the terminal itself, the terminal subsequently does not need to receive and process the second channel scheduled by the first information. Thus, unnecessary reception and processing of the second channel by the terminal may be avoided, the power consumption of the terminal is saved, and communication efficiency is improved.

In combination with some embodiments in the first aspect, in some embodiments, the first information is configured to schedule a second channel, and the second channel is configured to carry a message B (MsgB) or a Msg2.

In combination with some embodiments in the first aspect, in some embodiments, the first channel is a Physical Downlink Control Channel (PDCCH), the second channel is a Physical Downlink Shared Channel (PDSCH), and the first information is Downlink Control Information (DCI).

In combination with some embodiments in the first aspect, in some embodiments, the first resource includes at least one of a Bandwidth Part (BWP) for transmitting the first information, a frequency domain resource corresponding to the first information, or a time domain resource corresponding to the first information.

In combination with some embodiments in the first aspect, in some embodiments, the frequency domain resource includes a Control Resource Set (CORESET). The time domain resource includes at least one of a search space or a Physical Downlink Control Channel Monitoring Occasion (PMO).

In combination with some embodiments in the first aspect, in some embodiments, the first identifier is a Radio Network Temporary Identifier (RNTI).

In combination with some embodiments in the first aspect, in some embodiments, the reference signal resource includes at least one of a Demodulation Reference Signal (DMRS) time domain position, a DMRS frequency domain position, or a DMRS sequence.

In combination with some embodiments in the first aspect, in some embodiments, determining the first resource includes at least one of: obtaining the first resource configured by a network device; or determining the first resource based on a specification in a protocol.

Determining the first identifier includes at least one of: obtaining the first identifier configured by the network device; or determining the first identifier based on the specification in the protocol.

Determining the reference signal resource includes at least one of: obtaining the reference signal resource configured by the network device; or determining the reference signal resource based on the specification in the protocol.

In combination with some embodiments in the first aspect, in some embodiments, determining the first resource includes at least one of: determining, in a case where the terminal is the type 1 terminal, the first resource corresponding to the type 1 terminal based on at least one of: the specification in the protocol or configuration of the network device; or determining, in a case where the terminal is the type 2 terminal, the first resource corresponding to the type 2 terminal based on at least one of: the specification in the protocol or the configuration of the network device.

Alternatively, determining the first resource includes: determining, in a case where the terminal is the type 1 terminal, the first resource corresponding to the type 2 terminal based on at least one of: the specification in the protocol or the configuration of the network device; determining a first offset based on at least one of: the specification in the protocol or the configuration of the network device; and determining the first resource corresponding to the type 1 terminal based on the first offset and the first resource corresponding to the type 2 terminal.

Alternatively, determining the first resource includes: determining, in a case where the terminal is the type 2 terminal, the first resource corresponding to the type 1 terminal based on at least one of: the specification in the protocol or the configuration of the network device; determining a second offset based on at least one of: the specification in the protocol or the configuration of the network device; and determining the first resource corresponding to the type 2 terminal based on the second offset and the first resource corresponding to the type 1 terminal.

In combination with some embodiments in the first aspect, in some embodiments, after determining the first resource, the method further includes: receiving, in a case where the terminal is the type 1 terminal, the first information based on the first resource corresponding to the type 1 terminal; and receiving, in a case where the terminal is the type 2 terminal, the first information based on the first resource corresponding to the type 2 terminal.

In combination with some embodiments in the first aspect, in some embodiments, the first indication is carried in at least one of a reserved bit, a newly-added bit, or an original bit of the first information.

In combination with some embodiments in the first aspect, in some embodiments, the capability of the type 1 terminal is higher than the capability of the type 2 terminal, or the capability of the type 2 terminal is higher than the capability of the type 1 terminal.

In combination with some embodiments in the first aspect, in some embodiments, the type 1 terminal is a non-eRedCap terminal, and the type 2 terminal is an eRedCap terminal; or the type 1 terminal is an eRedCap terminal, and the type 2 terminal is a non-eRedCap terminal.

In combination with some embodiments in the first aspect, in some embodiments, the method further includes: determining, based on the indication information, whether the first information is sent to the terminal itself or whether the first information is sent to a terminal type to which the terminal itself belongs; and determining, in a case where it is determined that the first information is not sent to the terminal itself or is not sent to the terminal type to which the terminal itself belongs, to perform at least one of the following operations: not reading the first information; not receiving a channel scheduled by the first information; or not reading the channel scheduled by the first information.

In a second aspect, an embodiment of the present disclosure provides a communication method. The communication method includes: configuring indication information for a terminal, where the indication information is configured to indicate at least one of an association relationship between first information and a terminal type, or an association relationship between the first information and the terminal, and the first information is configured to schedule a downlink channel.

In the above embodiment, the terminal may receive the indication information configured by the network device. The indication information is configured to indicate at least one of the association relationship between the first information and the terminal type, or the association relationship between the first information and the terminal. First information having an association relationship with a terminal type is information to be sent to such type of terminal, and first information having an association relationship with a terminal is information to be sent to the terminal. As can be seen, in the embodiments of the present disclosure, each type of terminal may determine, based on the indication information, whether the first information is sent to the terminal itself or whether the first information is sent to terminal types to which the terminal itself belongs, and there is no need to read the first information. In a case where the terminal determines that the first information is not sent to the terminal itself or the first information is not sent to the terminal type to which the terminal itself belongs, the terminal may not read the first information, or not receive a channel scheduled by the first information, or not read the channel scheduled by the first information. Thus, unnecessary reception and reading by the terminal may be avoided. Power consumption of the terminal is saved, and communication efficiency is improved.

In combination with some embodiments in the second aspect, in some embodiments, the terminal type includes at least one of a type 1 terminal or a type 2 terminal. A capability of the type 1 terminal is different from a capability of the type 2 terminal.

In combination with some embodiments in the second aspect, in some embodiments, configuring the indication information for the terminal includes at least one of: configuring a first resource for at least one of the type 1 terminal or the type 2 terminal, where the first resource is configured to transmit the first information, and a first resource corresponding to the type 1 terminal is different from a first resource corresponding to the type 2 terminal; configuring a first identifier for at least one of the type 1 terminal or the type 2 terminal, where the first identifier is configured to descramble the first information, and a first identifier corresponding to the type 1 terminal is different from a first identifier corresponding to the type 2 terminal; configuring a reference signal resource for at least one of the type 1 terminal or the type 2 terminal, where the reference signal resource is used for a channel estimation of a first channel, the first channel is configured to carry the first information, and a reference signal resource corresponding to the type 1 terminal is different from a reference signal resource corresponding to the type 2 terminal; or sending the first information carrying a first indication to at least one of the type 1 terminal or the type 2 terminal, where the first indication is configured to indicate that the first information is sent to the type 1 terminal or the type 2 terminal.

In the above embodiments, the type 1 terminal or the type 2 terminal may respectively determine the first resource. The resource is configured to transmit the first information.

The first resource corresponding to the type 1 terminal is different from the first resource corresponding to the type 2 terminal. The first resource corresponding to the type 1 terminal is different from the first resource corresponding to the type 2 terminal, such that the first resource for transmitting the type 1 terminal is distinguished from the first resource for transmitting the type 2 terminal. Thus, when the network device is about to send the first information to each type of terminal, the network device may send the first information to the type of terminal on the first resource corresponding to the type of terminal. In this way, the type 1 terminal may receive the first information for the type 1 terminal on the first resource corresponding to the type 1 terminal, and the type 2 terminal may receive the first information for the type 2 terminal on the first resource corresponding to the type 2 terminal. Each type of terminal may clearly know on which resource the first information for the terminal itself is received, such that unnecessary blind detection by the terminal may be avoided, and the power consumption of the terminal may be saved.

Moreover, since the first information of each type of terminal is transmitted using different resources, a situation where “first information received by a type of terminal is not sent to such type of terminal itself” cannot occur. Thus, unnecessary reading of the first information by the terminal may be avoided, the power consumption of the terminal is further saved, and communication efficiency is improved.

In the above embodiments, the type 1 terminal or the type 2 terminal may respectively determine the first identifier of the first information. The first identifier is configured to descramble the first information. The first identifier corresponding to the type 1 terminal is different from the first identifier corresponding to the type 2 terminal. The first identifier corresponding to the type 1 terminal is different from the first identifier corresponding to the type 2 terminal, such that the first information of different types of terminals is distinguished from each other. Thus, when the network device is about to send the first information to each type of terminal, the first information sent to the type of terminal may be scrambled by the first identifier corresponding to the type of terminal. Moreover, after the type of terminal receives the first information, the first information may be first descrambled based on the respective first identifier. In a case where descrambling succeeds, it indicates that the first information is sent to the terminal itself. In a case where the descrambling fails, it indicates that the first information is not sent to the terminal itself. As can be seen, in the embodiments of the present disclosure, the terminal may determine whether the first information is sent to the terminal itself by determining whether the terminal may successfully descramble the first information, and does not need to read the first information. Thus, unnecessary reading of the first information by the terminal is avoided. Moreover, in a case where it is determined that the first information is not sent to the terminal itself, the terminal subsequently does not need to receive the second channel (such as a Physical Downlink Shared Channel (PDSCH)) scheduled by the first information.

Thus, unnecessary reception and processing of the second channel by the terminal are also avoided, the power consumption of the terminal is saved, and communication efficiency is improved.

In the above embodiments, the type 1 terminal or the type 2 terminal may respectively determine the reference signal resource corresponding to the first information. The reference signal resource is used for the channel estimation of the first channel, and the first channel is configured to carry the first information. The reference signal resource corresponding to the type 1 terminal is different from the reference signal resource corresponding to the type 2 terminal. The reference signal resource corresponding to the type 1 terminal is different from the reference signal resource corresponding to the type 2 terminal, such that the reference signal resources of different types of terminals are distinguished from each other. Thus, when the network device is about to send the first information to each type of terminal, the network device may send the first information to the type of terminal based on the reference signal resource corresponding to the type of terminal. After the type of terminal receives the first information, whether the first information is transmitted to the terminal itself may be determined based on the reference signal resource corresponding to the terminal itself. For example, the terminal may first determine a reference signal sequence or extract a signal from the first channel based on the reference signal resource corresponding to the terminal itself, and determine whether a correlation peak may be generated between the reference signal sequence or the extracted signal and the original reference signal sequence. In a case where the correlation peak is generated, it is determined that the first information is transmitted to the terminal itself. In a case where no correlation peak is generated, it is determined that the first information is not sent to the terminal itself. As can be seen, in the embodiments of the present disclosure, the terminal may determine, by determining the reference signal of the first channel, whether the first information carried by the first channel is sent to the terminal itself, instead of directly reading the first information. Thus, unnecessary decoding of the first information by the terminal may be avoided. Moreover, in a case where it is determined that the first information is not sent to the terminal itself, the terminal subsequently does not need to receive the second channel (such as a PDSCH) scheduled by the first information. Thus, unnecessary reception and processing of the second channel by the terminal are also avoided, the power consumption of the terminal is saved, and communication efficiency is improved.

In the above embodiments, the type 1 terminal or the type 2 terminal may respectively receive the first information. The first indication is carried in the first information, and the first indication is configured to indicate that the first information is sent to the type 1 terminal or the type 2 terminal. Since the first indication is carried in the first information, after each type of terminal receives the first information, whether the first information is sent to the terminal itself may be determined based on the first indication in the first information. In a case where it is determined that the first information is not sent to the terminal itself, the terminal subsequently does not need to receive and process the second channel scheduled by the first information. Thus, unnecessary reception and processing of the second channel by the terminal may be avoided, the power consumption of the terminal is saved, and communication efficiency is improved.

In combination with some embodiments in the second aspect, in some embodiments, the first information is configured to schedule a second channel, and the second channel is configured to carry a MsgB or a Msg2.

In combination with some embodiments in the second aspect, in some embodiments, the first channel is a PDCCH, the second channel is a PDSCH, and the first information is DCI.

In combination with some embodiments in the second aspect, in some embodiments, the first resource includes at least one of a BWP for transmitting the first information, a frequency domain resource corresponding to the first information, or a time domain resource corresponding to the first information.

In combination with some embodiments in the second aspect, in some embodiments, the frequency domain resource includes a CORESET. The time domain resource includes at least one of a search space or a PMO.

In combination with some embodiments in the second aspect, in some embodiments, the first identifier is an RNTI.

In combination with some embodiments in the second aspect, in some embodiments, the reference signal resource includes at least one of a DMRS time domain position, a DMRS frequency domain position, or a DMRS sequence.

In combination with some embodiments in the second aspect, in some embodiments, configuring the first resource includes at least one of: configuring the first resource corresponding to the type 1 terminal for the type 1 terminal; or configuring the first resource corresponding to the type 2 terminal for the type 2 terminal.

Alternatively, configuring the first resource includes: configuring the first resource corresponding to the type 2 terminal for the type 1 terminal and the type 2 terminal; and configuring a first offset for the type 1 terminal, where the first offset is configured to determine the first resource corresponding to the type 1 terminal.

Alternatively, configuring the first resource includes: configuring the first resource corresponding to the type 1 terminal for the type 1 terminal and the type 2 terminal; and configuring a second offset for the type 2 terminal, where the second offset is configured to determine the first resource corresponding to the type 2 terminal.

In combination with some embodiments in the second aspect, in some embodiments, after configuring the first resource, the method further includes: sending the first information to the type 1 terminal based on the first resource corresponding to the type 1 terminal; and sending the first information to the type 2 terminal based on the first resource corresponding to the type 2 terminal.

In combination with some embodiments in the second aspect, in some embodiments, the first indication is carried in at least one of a reserved bit, a newly-added bit, or an original bit of the first information.

In combination with some embodiments in the second aspect, in some embodiments, the capability of the type 1 terminal is higher than the capability of the type 2 terminal, or the capability of the type 2 terminal is higher than the capability of the type 1 terminal.

In combination with some embodiments in the second aspect, in some embodiments, the type 1 terminal is a non-eRedCap terminal, and the type 2 terminal is an eRedCap terminal; or the type 1 terminal is an eRedCap terminal, and the type 2 terminal is a non-eRedCap terminal.

In a third aspect, an embodiment of the present disclosure provides a communication method. A communication system includes a type 1 terminal, a type 2 terminal, and a network device. A capability of the type 1 terminal is different from a capability of the type 2 terminal. The method includes: configuring, by the network device, indication information for a terminal, where the indication information is configured to indicate at least one of an association relationship between first information and a terminal type, or an association relationship between the first information and the terminal, and the first information is configured to schedule a downlink channel.

In a fourth aspect, an embodiment of the present disclosure provides a first communication device. The first communication device includes: a determining module, configured to determine indication information, where the indication information is configured to indicate at least one of an association relationship between first information and a terminal type, or an association relationship between the first information and a terminal, and the first information is configured to schedule a downlink channel.

In combination with some embodiments in the fourth aspect, in some embodiments, the terminal type includes at least one of a type 1 terminal or a type 2 terminal. A capability of the type 1 terminal is different from a capability of the type 2 terminal.

In combination with some embodiments in the fourth aspect, in some embodiments, the determining module is further configured to perform at least one of: determining a first resource, where the first resource is configured to transmit the first information, and a first resource corresponding to the type 1 terminal is different from a first resource corresponding to the type 2 terminal; determining a first identifier, where the first identifier is configured to descramble the first information, and a first identifier corresponding to the type 1 terminal is different from a first identifier corresponding to the type 2 terminal; determining a reference signal resource, where the reference signal resource is used for a channel estimation of a first channel, the first channel is configured to carry the first information, and a reference signal resource corresponding to the type 1 terminal is different from a reference signal resource corresponding to the type 2 terminal; or determining a first indication carried in received first information, where the first indication is configured to indicate that the first information is sent to the type 1 terminal or the type 2 terminal.

In combination with some embodiments in the fourth aspect, in some embodiments, the first information is configured to schedule a second channel, and the second channel is configured to carry a MsgB or a Msg2.

In combination with some embodiments in the fourth aspect, in some embodiments, the first channel is a PDCCH, the second channel is a PDSCH, and the first information is DCI.

In combination with some embodiments in the fourth aspect, in some embodiments, the first resource includes at least one of a BWP for transmitting the first information, a frequency domain resource corresponding to the first information, or a time domain resource corresponding to the first information.

In combination with some embodiments in the fourth aspect, in some embodiments, the frequency domain resource includes a CORESET. The time domain resource includes at least one of a search space or a PMO.

In combination with some embodiments in the fourth aspect, in some embodiments, the first identifier is an RNTI.

In combination with some embodiments in the fourth aspect, in some embodiments, the reference signal resource includes at least one of a DMRS time domain position, a DMRS frequency domain position, or a DMRS sequence.

In combination with some embodiments in the fourth aspect, in some embodiments, the determining module is further configured to perform at least one of: obtaining the first resource configured by a network device; or determining the first resource based on a specification in a protocol.

The determining module is further configured to perform at least one of: obtaining the first identifier of the first information configured by the network device; or determining the first identifier of the first information based on the specification in the protocol.

The determining module is further configured to perform at least one of: obtaining the reference signal resource configured by the network device; or determining the reference signal resource based on the specification in the protocol.

In combination with some embodiments in the fourth aspect, in some embodiments, the module is further configured to perform at least one of: determining, in a case where the terminal is the type 1 terminal, the first resource corresponding to the type 1 terminal based on at least one of: the specification in the protocol or configuration of the network device; or determining, in a case where the terminal is the type 2 terminal, the first resource corresponding to the type 2 terminal based on at least one of: the specification in the protocol or the configuration of the network device.

Alternatively, the determining module is further configured to: determine, in a case where the terminal is the type 1 terminal, the first resource corresponding to the type 2 terminal based on at least one of: the specification in the protocol or the configuration of the network device; determine a first offset based on at least one of: the specification in the protocol or the configuration of the network device; and determine the first resource corresponding to the type 1 terminal based on the first offset and the first resource corresponding to the type 2 terminal.

Alternatively, the determining module is further configured to: determine, in a case where the terminal is the type 2 terminal, the first resource corresponding to the type 1 terminal based on at least one of: the specification in the protocol or the configuration of the network device; determine a second offset based on at least one of: the specification in the protocol or the configuration of the network device; and determine the first resource corresponding to the type 2 terminal based on the second offset and the first resource corresponding to the type 1 terminal.

In combination with some embodiments in the fourth aspect, in some embodiments, after determining the first resource, the device is further configured to: receive, in a case where the terminal is the type 1 terminal, the first information based on the first resource corresponding to the type 1 terminal; and receive, in a case where the terminal is the type 2 terminal, the first information based on the first resource corresponding to the type 2 terminal.

In combination with some embodiments in the fourth aspect, in some embodiments, the first indication is carried in at least one of a reserved bit, a newly-added bit, or an original bit of the first information.

In combination with some embodiments in the fourth aspect, in some embodiments, the capability of the type 1 terminal is higher than the capability of the type 2 terminal, or the capability of the type 2 terminal is higher than the capability of the type 1 terminal.

In combination with some embodiments in the fourth aspect, in some embodiments, the type 1 terminal is a non-eRedCap terminal, and the type 2 terminal is an eRedCap terminal; or the type 1 terminal is an eRedCap terminal, and the type 2 terminal is a non-eRedCap terminal.

In combination with some embodiments in the fourth aspect, in some embodiments, the device is further configured to: determine, based on the indication information, whether the first information is sent to the terminal itself or whether the first information is sent to a terminal type to which the terminal itself belongs; and determine, in a case where it is determined that the first information is not sent to the terminal itself or is not sent to the terminal type to which the terminal itself belongs, to perform at least one of the following operations: not reading the first information; not receiving a channel scheduled by the first information; or not reading the channel scheduled by the first information.

In a fifth aspect, an embodiment of the present disclosure provides a second communication device. The second communication device includes: a sending module, configured to configure indication information for a terminal, where the indication information is configured to indicate at least one of an association relationship between first information and a terminal type, or an association relationship between the first information and the terminal, and the first information is configured to schedule a downlink channel.

In combination with some embodiments in the fifth aspect, in some embodiments, the terminal type includes at least one of a type 1 terminal or a type 2 terminal. A capability of the type 1 terminal is different from a capability of the type 2 terminal.

In combination with some embodiments in the fifth aspect, in some embodiments, the sending module is further configured to perform at least one of: configuring a first resource for at least one of the type 1 terminal or the type 2 terminal, where the first resource is configured to transmit the first information, and a first resource corresponding to the type 1 terminal is different from a first resource corresponding to the type 2 terminal; configuring a first identifier for at least one of the type 1 terminal or the type 2 terminal, where the first identifier is configured to descramble the first information, and a first identifier corresponding to the type 1 terminal is different from a first identifier corresponding to the type 2 terminal; configuring a reference signal resource for at least one of the type 1 terminal or the type 2 terminal, where the reference signal resource is used for a channel estimation of a first channel, the first channel is configured to carry the first information, and a reference signal resource corresponding to the type 1 terminal is different from a reference signal resource corresponding to the type 2 terminal; or sending the first information carrying a first indication to at least one of the type 1 terminal or the type 2 terminal, where the first indication is configured to indicate that the first information is sent to the type 1 terminal or the type 2 terminal.

In combination with some embodiments in the fifth aspect, in some embodiments, the first information is configured to schedule a second channel, and the second channel is configured to carry a MsgB or a Msg2.

In combination with some embodiments in the fifth aspect, in some embodiments, the first channel is a PDCCH, the second channel is a PDSCH, and the first information is DCI.

In combination with some embodiments in the fifth aspect, in some embodiments, the first resource includes at least one of a BWP for transmitting the first information, a frequency domain resource corresponding to the first information, or a time domain resource corresponding to the first information.

In combination with some embodiments in the fifth aspect, in some embodiments, the frequency domain resource includes a CORESET. The time domain resource includes at least one of a search space or a PMO.

In combination with some embodiments in the fifth aspect, in some embodiments, the first identifier is an RNTI.

In combination with some embodiments in the fifth aspect, in some embodiments, the reference signal resource includes at least one of a DMRS time domain position, a DMRS frequency domain position, or a DMRS sequence.

In combination with some embodiments in the fifth aspect, in some embodiments, configuring the first resource includes at least one of: configuring the first resource corresponding to the type 1 terminal for the type 1 terminal; or configuring the first resource corresponding to the type 2 terminal for the type 2 terminal.

Alternatively, configuring the first resource includes: configuring the first resource corresponding to the type 2 terminal for the type 1 terminal and the type 2 terminal; and configuring a first offset for the type 1 terminal, where the first offset is configured to determine the first resource corresponding to the type 1 terminal.

Alternatively, configuring the first resource includes: configuring the first resource corresponding to the type 1 terminal for the type 1 terminal and the type 2 terminal; and configuring a second offset for the type 2 terminal, where the second offset is configured to determine the first resource corresponding to the type 2 terminal.

In combination with some embodiments in the fifth aspect, in some embodiments, after configuring the first resource, the device is further configured to: send the first information to the type 1 terminal based on the first resource corresponding to the type 1 terminal; and send the first information to the type 2 terminal based on the first resource corresponding to the type 2 terminal.

In combination with some embodiments in the fifth aspect, in some embodiments, the first indication is carried in at least one of a reserved bit, a newly-added bit, or an original bit of the first information.

In combination with some embodiments in the fifth aspect, in some embodiments, the capability of the type 1 terminal is higher than the capability of the type 2 terminal, or the capability of the type 2 terminal is higher than the capability of the type 1 terminal.

In combination with some embodiments in the fifth aspect, in some embodiments, the type 1 terminal is a non-eRedCap terminal, and the type 2 terminal is an eRedCap terminal; or the type 1 terminal is an eRedCap terminal, and the type 2 terminal is a non-eRedCap terminal.

In a sixth aspect, an embodiment of the present disclosure provides a communication device. The above communication device includes one or more processors, and one or more memories for storing instructions. The above processor is configured to invoke the above instructions to enable the above communication device to perform the communication method described in the first aspect, the second aspect, an optional implementation in the first aspect, and an optional implementation in the second aspect.

In a seventh aspect, an embodiment of the present disclosure provides a communication system. The above communication system includes a terminal and a network device. The above terminal is configured to perform the method described in the first aspect and an optional implementation in the first aspect. The above network device is configured to perform the method described in the second aspect and an optional implementation in the second aspect.

In an eighth aspect, an embodiment of the present disclosure provides a storage medium. The above storage medium stores instructions. The above instructions, when run on a communication device, enable the above communication device to perform the method described in the first aspect, an optional implementation in the first aspect, the second aspect, and an optional implementation in the second aspect.

In a ninth aspect, an embodiment of the present disclosure provides a program product.

The above program product, when executed by a communication device, enables the above communication device to perform the method described in the first aspect, an optional implementation in the first aspect, the second aspect, and an optional implementation in the second aspect.

In a tenth aspect, an embodiment of the present disclosure provides a computer program. The computer program, when run on a computer, enables the computer to perform the method described in the first aspect, an optional implementation in the first aspect, the second aspect, and an optional implementation in the second aspect.

It is to be understood that the first communication device, the second communication device, the communication device, the communication system, the storage medium, the program product, and the computer program mentioned above are all configured to perform the method provided by the embodiments of the present disclosure. Thus, the beneficial effects that may be achieved may be obtained with reference to the beneficial effects in the corresponding methods, which are not repeated here.

The embodiments of the present disclosure provide the title of the invention. In some embodiments, terms such as communication method, method for processing information, method for sending information, and method for receiving information are interchangeable. Terms such as communication device, device for processing information, device for sending information, and device for receiving information are interchangeable. Terms such as system for processing information, communication system, system for sending information, and system for receiving information are interchangeable.

The embodiments of the present disclosure are not exhaustive, are merely illustrative of some embodiments, and are not intended to impose specific limitations on the scope of protection of the present disclosure. In a case of no contradiction, each step in an embodiment may be implemented as an independent embodiment, and steps may be freely combined. For example, a solution obtained by removing some steps from an embodiment may also be implemented as an independent embodiment, and a sequence of steps in an embodiment may be freely exchanged. Moreover, optional implementations in an embodiment may be freely combined. In addition, embodiments may be freely combined. For example, some or all steps in different embodiments may be freely combined, and an embodiment may be freely combined with optional implementations in other embodiments.

In the embodiments of the present disclosure, in a case of no special description and logical conflict, at least one of terms or descriptions among the embodiments have consistency and may refer to each other. Technical features in different embodiments may be combined to form new embodiments according to inherent logical relationships of the technical features.

Terms used in the embodiments of the present disclosure are only for the purpose of describing particular embodiments and are not intended to limit the present disclosure.

In the embodiments of the present disclosure, unless otherwise stated, an element denoted in singular form, such as “a,” “an,” “this,” “the above,” “the,” “the foregoing,” “such a,” may denote “one and only one,” and may further denote “one or more,” “at least one,” etc. For example, in a case where articles such as “a,” “an,” and “the” in English are used in translation, nouns following the articles may be understood as singular expressions or plural expressions.

In the embodiments of the present disclosure, “a plurality of” refers to two or more.

In some embodiments, terms such as “at least one of,” “one or more,” “a plurality of,” and “multiple” are interchangeable.

Descriptions such as “at least one of A, B, C . . . ” and “A and/or B and/or C . . . ” in the embodiments of the present disclosure include any one of A, B, C . . . alone, and further include any combinations of A, B, C . . . , and each case may exist alone. For example, “at least one of A, B, or C” includes A alone, B alone, C alone, a combination of A and B, a combination of A and C, a combination of B and C, and a combination of A, B, and C. For another example, A and/or B include A alone, B alone, or a combination of A and B.

In some embodiments, expressions “A in a case, and B in another case,” “A in response to a case, and B in response to another case,” etc. may include, according to situations, solutions as follows: A is performed independently of B, that is, A in some embodiments; B is performed independently of A, that is, B in some embodiments; A and B are selectively performed, that is, A and B are selectively performed in some embodiments; and both A and B are performed, that is, A and B in some embodiments. A case of more branches of A, B, C, etc. is similar to the above.

Prefix words such as “first” and “second” in the embodiments of the present disclosure are only used to distinguish different described objects, and do not constitute limitations on the position, order, priority, number, or content of the described object. Statements of the described objects may be obtained with reference to the descriptions of the context in the claims or the embodiments, and should not constitute redundant limitations due to the usage of the prefix words. For example, in a case where a described object is a “field”, ordinal numbers before the “field” in a “first field” and a “second field” do not limit the position or order of the “field”. The “first” and “second” do not limit whether the modified “field” is in the same message, and do not limit the order of the “first field” and the “second field”. For another example, in a case where a described object is a “grade”, ordinal numbers before the “grade” in a “first grade” and a “second grade” do not limit the priority of the “grade”. For yet another example, the number of described objects is not limited by ordinal numbers, and may be one or more. Taking a “first device” as an example, the number of the “device” may be one or more. In addition, objects modified by different prefix words may be the same or different. For example, in a case where a described object is an “device”, a “first device” and a “second device” may be the same device or different devices, and may be of the same type or different types. For another example, in a case where a described object is “information,” “first information,” and “second information” may be the same information or different information, and may have the same content or different content.

In some embodiments, “including A,” “containing A,” “for indicating A,” and “carrying A” may be interpreted as directly carrying A or indirectly indicating A.

In some embodiments, terms such as “in response to . . . ,” “in response to determining . . . ,” “in a situation where . . . ,” “in a case where . . . ,” “when . . . ,” “if . . . ,” “under the condition . . . ,” are interchangeable.

In some embodiments, terms such as “greater than,” “greater than or equal to,” “not less than,” “more than,” “more than or equal to,” “not fewer than,” “higher than,” “higher than or equal to,” “not lower than,” and “above” are interchangeable. Terms such as “less than,” “less than or equal to,” “not greater than,” “fewer than,” “fewer than or equal to,” “not more than,” “lower than,” “lower than or equal to,” “not higher than,” and “below” are interchangeable.

In some embodiments, devices, etc. may be interpreted as physical or virtual, and their names are not limited to the names recited in the embodiments. Terms such as “apparatus,” “equipment,” “device,” “circuit,” “network element,” “node,” “function,” “unit,” “section,” “system,” “network,” “chip,” “system on chip,” “entity,” and “main body” are interchangeable.

In some embodiments, the “network” may be interpreted as a device (such as an access network device and a core network device) included in the network.

In some embodiments, terms such as “access network device (AN device),” “radio access network device (RAN device),” “base station (BS),” “radio base station,” “fixed station,” “node,” “access point,” “transmission point (TP),” “reception point (RP),” “transmission/reception point (TRP),” “panel,” “antenna panel,” “antenna array,” “cell,” “macro cell,” “small cell,” “femto cell,” “pico cell,” “sector,” “cell group,” “carrier,” “component carrier,” and “bandwidth part (BWP)” are interchangeable.

In some embodiments, terms such as “terminal,” “terminal device,” “user equipment (UE),” “user terminal,” “mobile station (MS),” “mobile terminal (MT),” “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” and “client” are interchangeable.

In some embodiments, an access network device, a core network device, or a network device may be replaced with a terminal. For example, in a case of a structure in which communication between an access network device, a core network device, or a network device and a terminal is replaced with communication among a plurality of terminals (which may also be referred to as device-to-device (D2D), vehicle-to-everything (V2X), etc. for example), the embodiments of the present disclosure may be applied. In such a case, the terminal may be set to have a structure having all or some functions of the access network device. Languages such as “uplink” and “downlink” may also be replaced with languages corresponding to communication between terminals (such as “side”). For example, an uplink channel, a downlink channel, etc., may be replaced with a side channel. An uplink, a downlink, etc., may be replaced with a side link.

In some embodiments, the terminal may be replaced with the access network device, the core network device, or the network device. In such a case, the access network device, the core network device, or the network device may be set to have a structure having all or some functions of the terminal.

In some embodiments, obtaining data, information, etc., may comply with laws and regulations of the local country.

In some embodiments, data, information, etc. may be obtained after consent of a user is obtained.

In addition, each element, each row, or each column in the table of the embodiments of the present disclosure may be implemented as an independent embodiment, and a combination of any element, any row, and any column may also be implemented as an independent embodiment.

Corresponding relationships shown in the tables in the present disclosure may be configured or pre-defined. Values of information in the tables are merely examples, and may be configured as other values, which are not limited to those in the present disclosure. When a corresponding relationship between information and each parameter is configured, not all the corresponding relationships shown in the tables are required to be configured.

For example, in the tables in the present disclosure, corresponding relationships shown in some rows may not be configured. For another example, appropriate deformation adjustments may be made based on the above tables, such as splitting and merging. Other names that may be understood by the communication device may be used as names of parameters shown in the titles of the above tables. Other values or expressions that may be understood by the communication device may be used as values or expressions of the parameters. When the above tables are implemented, other data structures may be used, such as an array, a queue, a container, a stack, a linear table, a pointer, a linked list, a tree, a graph, a structure, a class, a heap, and a hash table.

Pre-definition in the present disclosure may be understood as definition, definition in advance, storage, pre-storage, pre-negotiation, pre-configuration, solidification, or pre-firing.

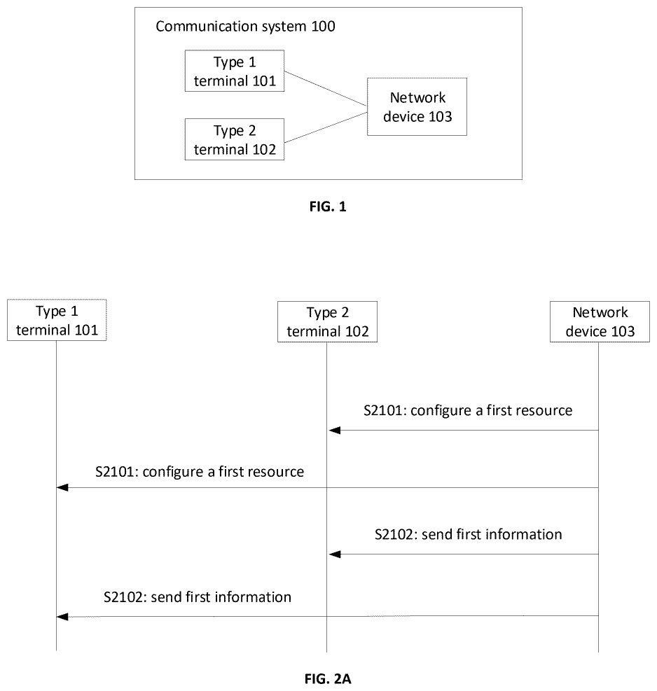

FIG. 1 is a schematic diagram of an architecture of a communication system according to an embodiment of the present disclosure. As shown in FIG. 1, the communication system 100 may include a type 1 terminal 101, a type 2 terminal 102, and a network device 103. In some examples, a capability of the type 1 terminal is different from a capability of the type 2 terminal. For example, the capability of the type 1 terminal is higher than the capability of the type 2 terminal; or the capability of the type 2 terminal is higher than the capability of the type 1 terminal. The network device 103 may include at least one of an access network device or a core network device.

In some embodiments, each of the type 1 terminal 101 and the type 2 terminal 102 includes, for example, at least one of a mobile phone, a wearable device, an internet of things device, a car having a communication function, a smart car, a pad, a computer having a wireless transceiver function, a virtual reality (VR) terminal, an augmented reality (AR) terminal, a wireless terminal in industrial control, a wireless terminal in self-driving, a wireless terminal in remote medical surgery, a wireless terminal in a smart grid, a wireless terminal in transportation safety, a wireless terminal in a smart city, or a wireless terminal in a smart home, but is not limited thereto.

In some embodiments, an access network device is, for example, a node or device that accesses a terminal to a wireless network. The access network device may include at least one of an evolved Node B (eNB) in a 5G communication system, a next generation eNB (ng-eNB), a next generation Node B (gNB), a Node B (NB), a home Node B (HNB), a home evolved Node B (HeNB), a wireless backhaul device, a radio network controller (RNC), a base station controller (BSC), a base transceiver station (BTS), a base band unit (BBU), a mobile switching center, a base station in a 6G communication system, an open RAN, a cloud RAN, a base station in another communication system, or an access node in a wireless fidelity (WiFi) system, but is not limited thereto.

In some embodiments, the technical solution of the present disclosure may apply to an open RAN architecture. In such a case, interfaces between or in access network devices involved in the embodiments of the present disclosure may be changed to internal interfaces of the open RAN. Flows and information interaction between these internal interfaces may be implemented by software or programs.

In some embodiments, the access network device may be composed of a central unit (CU) and a distributed unit (DU). The CU may also be referred to as a control unit. By using the CU-DU structure, protocol layers of the access network device may be split. Functions of some protocol layers are centrally controlled in the CU, functions of some or all of the remaining protocol layers are distributed in the DU, and the DU is centrally controlled by the CU, without being limited thereto.

In some embodiments, the core network device may be one device including one or more network elements, or may be a plurality of devices or a device group respectively including all or some of one or more network elements. The network element may be virtual or physical. The core network includes, for example, at least one of an Evolved Packet Core (EPC), a 5G Core Network (5GCN), or a Next Generation Core (NGC).

It is to be understood that the communication system described in the embodiments of the present disclosure is for explaining the technical solutions of the embodiments of the present disclosure more clearly, and does not constitute limitations on the technical solutions provided by the embodiments of the present disclosure. A person of ordinary skill in the art may know that as system architectures evolve and new service scenarios appear, the technical solutions provided by the embodiments of the present disclosure are also applicable to similar technical problems.

The following embodiments of the present disclosure may be applied to the communication system 100 or some of the main bodies shown in FIG. 1, but are not limited thereto. Main bodies shown in FIG. 1 are examples. The communication system may include all or some of the main bodies shown in FIG. 1, or may include a main body other than those shown in FIG. 1. The number and form of the main bodies are arbitrary. The connection relationship among the main bodies is an example. The main bodies may be connected or not. The connection may be any connection, may be a direct connection or an indirect connection, or may be a wired connection or a wireless connection.

The embodiments of the present disclosure may be applied to Long Term Evolution (LTE), LTE-Advanced (LTE-A), LTE-Beyond (LTE-B), SUPER 3G, IMT-Advanced, a 4th generation mobile communication system (4G), a 5th generation mobile communication system (5G), 5G New Radio (NR), Future Radio Access (FRA), a New-Radio Access Technology (RAT), New Radio (NR), New radio access (NX), Future generation radio access (FX), a Global System for Mobile communications (GSM (registered trademark)), CDMA2000, Ultra Mobile Broadband (UMB), the Institute of Electrical and Electronics Engineers (IEEE) 802.11 (Wi-Fi (registered trademark)), the IEEE 802.16 (WiMAX (registered trademark)), the IEEE 802.20, Ultra-Wideband (UWB), the Bluetooth (registered trademark), a Public Land Mobile Network (PLMN), a Device-to-Device (D2D) system, a Machine-to-Machine (M2M) system, an Internet of Things (IoT) system, Vehicle-to-Everything (V2X), a system using another communication method, a next-generation system expanded based on the foregoing, etc. In addition, a plurality of systems may be combined (such as a combination of LTE or LTE-A and 5G) for an application.

For ease of understanding, terms involved in the present disclosure are first introduced.

### 1. Reduced Capability (Redcap) Terminal

A reduced capability terminal is a lightweight 5G terminal with a new technical standard, which is specially researched by the 3rd Generation Partnership Project (3GPP) at 5G R17 .

2. eRedcap Terminal

An eRedCap terminal is a further evolution on the basis of the RedCap terminal by the 3GPP at 5G R18. Compared with the RedCap terminal, the eRedCap terminal has lower terminal implementation complexity.

The present disclosure may be applicable to both the R17 RedCap terminal and the R18 eRedCap terminal, and may further be applicable to other reduced capability terminals defined by future standards. That is, the RedCap terminal in the present disclosure may be the R17 RedCap terminal, the R18 eRedCap terminal, or another reduced capability terminal defined by a future standard.

In some embodiments, compared with a normal terminal (that is, a non-RedCap terminal and a non-eRedCap terminal, such as a legacy terminal), the Redcap terminal (or the eRedCap terminal) has a reduced baseband bandwidth. Thus, to ensure successful communication between the network device and the Redcap terminal (or the eRedCap terminal), when the network device needs to send a downlink channel to the Redcap terminal (or the eRedCap terminal), a resource occupied by the downlink channel does not exceed a channel baseband bandwidth of the Redcap terminal (or the eRedCap terminal). A resource occupied by a downlink channel sent to the normal terminal may exceed the channel baseband bandwidth of the Redcap terminal (or the eRedCap terminal). Thus, in some embodiments, the network device may schedule downlink channels for the Redcap terminal (or the eRedCap terminal) and the normal terminal separately. That is, scheduling information for scheduling a downlink channel of the Redcap terminal (or the eRedCap terminal) is sent to the Redcap terminal (or the eRedCap terminal), and scheduling information for scheduling a downlink channel of the normal terminal is sent to the normal terminal.

However, when the network device schedules downlink channels for the above two types of terminals separately, the following situations generally occur: the normal terminal receives the scheduling information that needs to be sent to the Redcap terminal (or the eRedCap terminal), or the Redcap terminal (or the eRedCap terminal) receives the scheduling information that needs to be sent to the normal terminal. In such case, the Redcap terminal (or the eRedCap terminal) and the normal terminal generally may determine whether the scheduling information is sent to the terminal itself after descrambling and reading the scheduling information.

For example, when contention random access occurs between the Redcap terminal (or the eRedCap terminal) and the normal terminal, in a case where the Redcap terminal (or the eRedCap terminal) and the normal terminal share the same random access channel occasion (RO) to perform Physical Random Access Channel (PRACH) transmission, the Redcap terminal (or the eRedCap terminal) may receive scheduling information for scheduling an MsgB or Msg2 of the normal terminal, or the normal terminal may receive scheduling information for scheduling an MsgB or Msg2 of the Redcap terminal (or the eRedCap terminal). In such case, since the Redcap terminal (or the eRedCap terminal) and the normal terminal share the same RO, Radio Network Temporary Identifiers (RNTIs) of the scheduling information of the two types of terminals may be the same. Then, the Redcap terminal (or the eRedCap terminal) may successfully decode and read the scheduling information of the MsgB or Msg2 of the normal terminal by the RNTI of the Redcap terminal (or the eRedCap terminal) itself, and the normal terminal may successfully decode and read the scheduling information of the MsgB or Msg2 of the RedCap terminal (or the eRedCap terminal) by the RNTI of the normal terminal itself. Thus, the RedCap terminal (or the eRedCap terminal) and the normal terminal cannot determine, in a manner of “determining whether the RNTI of the terminal itself may successfully decode the received scheduling information”, whether the received scheduling information is sent to the terminal itself, but need to decode and read the scheduling information and then determine, based on the content of the scheduling information, whether the scheduling information is sent to the terminal itself. Consequently, unnecessary blind detection and reading of information by the terminal may be caused, and power consumption of the terminal may be increased.

Alternatively, in some other embodiments, after receiving the scheduling information, the terminal cannot determine whether the scheduling information is sent to the terminal itself at all. Then, the terminal may subsequently detect and receive a downlink channel scheduled by the scheduling information, and may read the downlink channel. In such case, in a case where neither the scheduling information nor the downlink channel is sent to the terminal, unnecessary blind detection and reading of information by the terminal may also be caused, and power consumption of the terminal may be increased.

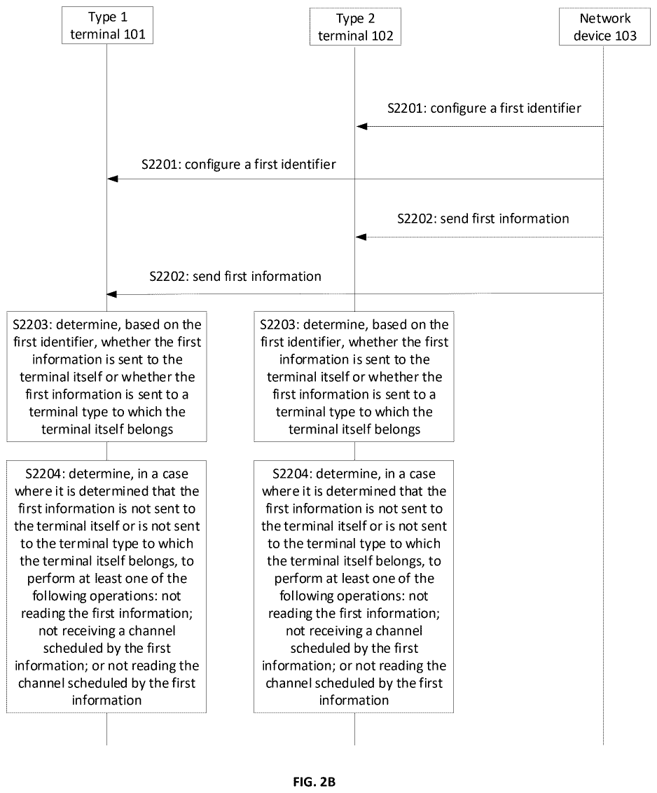

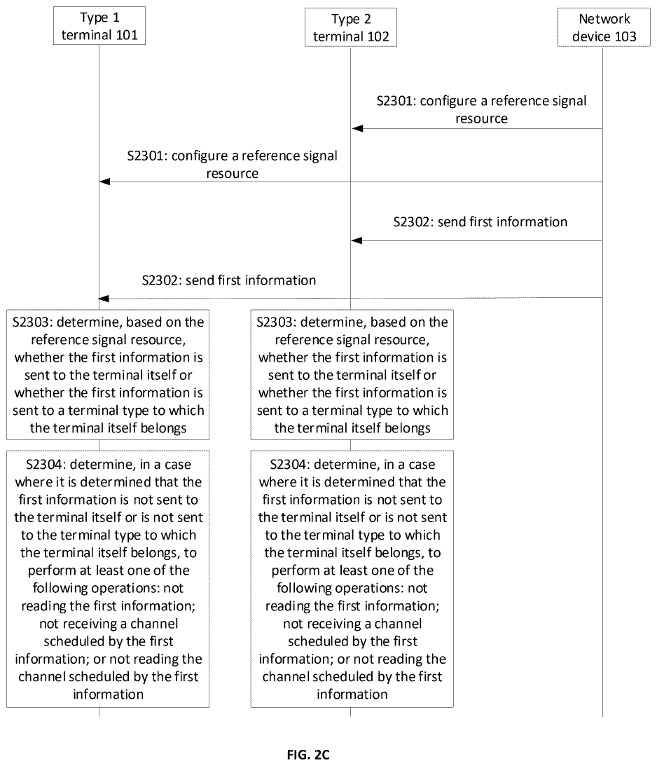

FIG. 2A is a schematic diagram of the interaction of a communication method according to an embodiment of the present disclosure. As shown in FIG. 2A, an embodiment of the present disclosure relates to a communication method. The above communication method is applied to a communication system 100 and includes the following steps 2101 and 2102. In step 2101, a network device configures a first resource for at least one of a type 1 terminal or a type 2 terminal.

In some embodiments, a capability of the type 1 terminal is different from a capability of the type 2 terminal. In some examples, the capability of the type 1 terminal may be higher than the capability of the type 2 terminal. For example, the type 1 terminal is a “non-eRedCap terminal,” a “non-RedCap terminal,” a “legacy terminal,” etc., and the type 2 terminal is an “eRedCap terminal,” a “RedCap terminal,” a “Rel-18 RedCap terminal,” a “Rel-17 RedCap terminal,” etc. Alternatively, the capability of the type 2 terminal may be higher than the capability of the type 1 terminal. For example, the type 1 terminal is an “eRedCap terminal,” a “RedCap terminal,” a “Rel-18 RedCap terminal,” a “Rel-17 RedCap terminal,” etc., and the type 2 terminal is a “non-eRedCap terminal,” a “non-RedCap terminal,” a “legacy terminal,” etc. In some examples, the name of the type 1 terminal and the name of the type 2 terminal are not limited.

In some embodiments, the above first resource may be configured to transmit first information. In some examples, the first information may be carried in a first channel. The first information may be scheduling information, for example, may be configured to schedule a downlink channel. In some embodiments, the first information may be information for scheduling a second channel in a random access process. For example, the first channel may be a PDCCH, the first information may be DCI, and the second channel may be a PDSCH. The second channel may be configured to carry a MsgB or a Msg2.

Usage scenarios of the first channel, the first information, and the second channel are introduced with examples in which the first channel is a PDCCH, the first information is DCI, and the second channel is a PDSCH.

For example, in a random access process, after the terminal sends a MsgA or a Msg1 to the network device, the network device generally replies a MsgB or a Msg2 to the terminal through a PDSCH (that is, the second channel). Moreover, before replying the MsgB or the Msg2 to the terminal through the PDSCH, the network device generally sends a PDCCH (that is, the first channel) to the terminal first. The PDCCH includes DCI (that is, the first information), and the DCI is configured to schedule the PDSCH carrying the MsgB or the Msg2. That is, the DCI is configured to indicate a start position, the number of resources, etc. of a transmission resource of the PDSCH carrying the MsgB or the Msg2. The terminal may receive, based on the DCI in the PDSCH, the PDSCH carrying the MsgB or the Msg2 on a corresponding resource such that successful reception of the PDSCH may be achieved.

In some embodiments, the above first resource is substantially a resource for transmitting the first information. In some examples, the first resource may include at least one of a BWP for transmitting the first information, a frequency domain resource corresponding to the first information, or a time domain resource corresponding to the first information.

In some examples, the above BWP for transmitting the first information may be, for example, an initial BWP. In some examples, the above frequency domain resource corresponding to the first information may include a CORESET. In some examples, the above time domain resource corresponding to the first information may include at least one of a search space or a PMO. In some examples, the above search space may be, for example, a Random Access Channel (RACH) search space.

In some embodiments, the above step that “a network device configures a first resource for at least one of a type 1 terminal or a type 2 terminal” may include at least one of: a step of configuring a first resource corresponding to the type 1 terminal for the type 1 terminal; or a step of configuring a first resource corresponding to the type 2 terminal for the type 2 terminal.

In some examples, the above “first resource corresponding to the type 1 terminal” may be understood, for example, as a resource for transmitting “first information needs to be sent to the type 1 terminal”. The above “first resource corresponding to the type 2 terminal” may be understood, for example, as a resource for transmitting “first information needs to be sent to the type 2 terminal”. The first resource corresponding to the type 1 terminal is different from the first resource corresponding to the type 2 terminal.

In some examples, the above “first resource corresponding to the type 1 terminal” may be the foregoing indication information corresponding to the type 1 terminal. The “first resource corresponding to the type 1 terminal” may indicate that first information transmitted on the first resource corresponding to the type 1 terminal has an association relationship with the type 1 terminal. In other words, the first information transmitted on the first resource corresponding to the type 1 terminal is information that needs to be sent to the type 1 terminal. In some examples, the above “first resource corresponding to the type 2 terminal” may be the foregoing indication information corresponding to the type 2 terminal. The “first resource corresponding to the type 2 terminal” may indicate that first information transmitted on the first resource corresponding to the type 2 terminal has an association relationship with the type 2 terminal. In other words, the first information transmitted on the first resource corresponding to the type 2 terminal is information needs to be sent to the type 2 terminal.

In some embodiments, the above step of “configuring the first resource corresponding to the type 1 terminal for the type 1 terminal, and configuring the first resource corresponding to the type 2 terminal for the type 2 terminal” may include the following steps. The network device configures a resource set for the type 1 terminal and the type 2 terminal respectively, and specifies that a first part of resources (such as a first half of resources) in the resource set is the first resource corresponding to the type 1 terminal, and a second part of resources (such as a second half of resources) in the resource set is the first resource corresponding to the type 2 terminal. Thus, after receiving the resource set configured by the network device, the type 1 terminal and the type 2 terminal may select, based on the specification, the first resource corresponding to the terminal itself from the resource set.

In some other embodiments, the above step of “configuring the first resource corresponding to the type 1 terminal for the type 1 terminal, and configuring the first resource corresponding to the type 2 terminal for the type 2 terminal” may include the following steps. The network device directly configures the first resource corresponding to the type 1 terminal for the type 1 terminal, and directly configures the first resource corresponding to the type 2 terminal for the type 2 terminal. Thus, the type 1 terminal or the type 2 terminal may directly determine the first resource configured by the network device as the first resource corresponding to the terminal itself.

For example, in some embodiments, the network device may configure a first BWP for transmitting the “first information needs to be sent to the type 1 terminal” for the type 1 terminal, and configure a second BWP for transmitting the “first information needs to be sent to the type 2 terminal” for the type 2 terminal. The first BWP is different from the second BWP.

Alternatively, in some other embodiments, the network device may configure a first CORESET corresponding to the type 1 terminal for the type 1 terminal, and configure a second CORESET corresponding to the type 2 terminal for the type 2 terminal. In some examples, the first CORESET may be configured to determine a frequency domain resource for transmitting the “first information needs to be sent to the type 1 terminal”. The second CORESET may be configured to determine a frequency domain resource for transmitting the “first information that needs to be sent to the type 2 terminal”. The first CORESET is different from the second CORESET.

Alternatively, in some other embodiments, the network device may configure a first search space corresponding to the type 1 terminal for the type 1 terminal, and configure a second search space corresponding to the type 2 terminal for the type 2 terminal. In some examples, the first search space may be configured to determine a time domain resource for transmitting the “first information needs to be sent to the type 1 terminal”. The second search space may be configured to determine a time domain resource for transmitting the “first information needs to be sent to the type 2 terminal”. The first search space is different from the second search space.

Alternatively, in some other embodiments, the network device may configure a first PMO corresponding to the type 1 terminal for the type 1 terminal, and configure a second PMO corresponding to the type 2 terminal for the type 2 terminal. In some examples, the first PMO may be configured to determine a time domain resource for transmitting the “first information needs to be sent to the type 1 terminal”. The second PMO may be configured to determine a time domain resource for transmitting the “first information needs to be sent to the type 2 terminal”. The first PMO is different from the second PMO.

In some embodiments, the network device may configure the first resource for at least one of the type 1 terminal or the type 2 terminal via first signaling. In some examples, the first signaling may include at least one of a Master Information Block (MIB), System Information Blocks (SIBs) (such as SIB1), or Radio Resource Control (RRC).

It is to be noted that in some embodiments, before configuring the first resource for the terminal, the network device may further receive a terminal type to which the terminal itself belongs reported by the terminal. In some examples, the terminal may report, to the network device via at least one of a Msg1, a Msg3 or a MsgA, that a terminal type to which the terminal itself belongs is the type 1 terminal or the type 2 terminal.

In some other embodiments, the above step that “a network device configures a first resource for at least one of a type 1 terminal or a type 2 terminal” may include the following steps. The first resource corresponding to the type 2 terminal is configured for the type 1 terminal and the type 2 terminal; and a first offset is configured for the type 1 terminal. The first offset is configured to determine the first resource corresponding to the type 1 terminal.

In some embodiments, a resource position of the first resource corresponding to the type 1 terminal may be a resource position after a resource position of the first resource corresponding to the type 2 terminal deviates by the first offset of resources. In some embodiments, the first offset may further be specified in a protocol.

For example, in some embodiments, the network device may configure the second BWP corresponding to the type 2 terminal for transmitting the “first information needs to be sent to the type 2 terminal” for both the type 1 terminal and the type 2 terminal. Moreover, the network device may configure the first offset for the type 1 terminal, such that the type 1 terminal determines, based on the first offset and the second BWP, the first BWP corresponding to the type 1 terminal for transmitting the “first information needs to be sent to the type 1 terminal”. In some examples, a resource position of the first BWP may be a resource position after a resource position of the second BWP deviates by the first offset of resources (such as Resource Blocks (RBs)).

Alternatively, in some other embodiments, the network device may configure the second CORESET of the first information corresponding to the type 2 terminal for both the type 1 terminal and the type 2 terminal. Moreover, the network device may configure the first offset for the type 1 terminal, such that the type 1 terminal determines, based on the first offset and the second CORESET, the first CORESET of the first information corresponding to the type 1 terminal. In some examples, a resource position of the first CORESET may be a resource position after a resource position of the second CORESET deviates by the first offset of resources (such as RBs).

Alternatively, in some other embodiments, the network device may configure the second search space of the first information corresponding to the type 2 terminal for both the type 1 terminal and the type 2 terminal. Moreover, the network device may configure the first offset for the type 1 terminal, such that the type 1 terminal determines, based on the first offset and the second search space, the first search space of the first information corresponding to the type 1 terminal. In some examples, a resource position of the first search space may be a resource position after a resource position of the second search space deviates by the first offset of resources (such as symbols or slots).

Alternatively, in some other embodiments, the network device may configure the second PMO of the first information corresponding to the type 2 terminal for both the type 1 terminal and the type 2 terminal. In some examples, the second PMO may be a PMO of a type 1 Common Search Space (CSS) of the type 2 terminal. Moreover, the network device may configure the first offset for the type 1 terminal, such that the type 1 terminal determines, based on the first offset and the second PMO, the first PMO of the first information corresponding to the type 1 terminal. In some examples, a resource position of the first PMO may be a resource position after a resource position of the second PMO deviates by the first offset of resources (such as symbols or slots).

In some other embodiments, the above step that “a network device configures a first resource for at least one of a type 1 terminal or a type 2 terminal” may include the following steps. The first resource corresponding to the type 1 terminal is configured for the type 1 terminal and the type 2 terminal; and a second offset is configured for the type 2 terminal. The second offset is configured to determine the first resource corresponding to the type 2 terminal.

In some examples, the resource position of the first resource corresponding to the type 2 terminal may be a resource position after the resource position of the first resource corresponding to the type 1 terminal deviates by the second offset of resources. In some embodiments, the second offset may be specified in the protocol.

For example, in some embodiments, the network device may configure the first BWP corresponding to the type 1 terminal for transmitting the “first information needs to be sent to the type 1 terminal” for both the type 1 terminal and the type 2 terminal. Moreover, the network device may configure the second offset for the type 2 terminal, such that the type 2 terminal determines, based on the second offset and the first BWP, the second BWP corresponding to the type 2 terminal for transmitting the “first information needs to be sent to the type 2 terminal”. In some examples, a resource position of the second BWP may be a resource position after a resource position of the first BWP deviates by the second offset of resources (such as RBs).

Alternatively, in some other embodiments, the network device may configure the first CORESET of the first information corresponding to the type 1 terminal for both the type 1 terminal and the type 2 terminal. Moreover, the network device may configure the second offset for the type 2 terminal, such that the type 2 terminal determines, based on the second offset and the first CORESET, the second CORESET of the first information corresponding to the type 2 terminal. In some examples, a resource position of the second CORESET may be a resource position after a resource position of the first CORESET deviates by the second offset of resources (such as RBs).

Alternatively, in some other embodiments, the network device may configure the first search space of the first information corresponding to the type 1 terminal for both the type 1 terminal and the type 2 terminal. Moreover, the network device may configure the second offset for the type 2 terminal, such that the type 2 terminal determines, based on the second offset and the first search space, the second search space of the first information corresponding to the type 2 terminal. In some examples, a resource position of the second search space may be a resource position after a resource position of the first search space deviates by the second offset of resources (such as symbols or slots).

Alternatively, in some other embodiments, the network device may configure the first PMO corresponding to the type 1 terminal for transmitting the first information for both the type 1 terminal and the type 2 terminal. In some examples, the first PMO may be a PMO of a type 1 CSS of the type 1 terminal. Moreover, the network device may configure the second offset for the type 2 terminal, such that the type 2 terminal determines, based on the second offset and the first PMO corresponding to the type 1 terminal for transmitting the first information, the second PMO corresponding to the type 2 terminal for transmitting the first information. In some examples, a resource position of the second PMO may be a resource position after a resource position of the first PMO deviates by the second offset of resources (such as symbols and slots).

In some embodiments, the network device may configure the first resource, the first offset, and the second offset via the first signaling. A detailed introduction of the first signaling may be obtained with reference to the above description.

In some embodiments, the network device may configure the first resource for the terminal when the terminal triggers random access, or may configure the first resource for the terminal before the terminal triggers the random access.

It is to be noted that in some embodiments, the network device may not configure the above first resource for the terminal. In such case, both the terminal and the network device may determine the first resource based on a specification in the protocol.

In step 2102, the network device sends the first information based on the first resource.

In some embodiments, the network device may send the first information to the type 1 terminal based on the first resource corresponding to the type 1 terminal, and send the first information to the type 2 terminal based on the first resource corresponding to the type 2 terminal. In some examples, the type 1 terminal may receive the first information based on the first resource corresponding to the type 1 terminal, and the type 2 terminal may receive the first information based on the first resource corresponding to the type 2 terminal.

The communication method related to the embodiment of the present disclosure may include at least one of steps S2101 or S2102. For example, step S2101 may be implemented as an independent embodiment, step S2102 may be implemented as an independent embodiment, and steps S2101+S2102 may be implemented as an independent embodiment, which is not limited thereto.

In the implementation or embodiment, in a case of no contradiction, the steps may be independent or freely combined, or a sequence of the steps may be changed. Optional implementations or examples may be freely combined, and may be freely combined with any step of other implementations or other embodiments.

FIG. 2B is a schematic diagram of the interaction of a communication method according to an embodiment of the present disclosure. As shown in FIG. 2B, an embodiment of the present disclosure relates to a communication method. The above communication method is applied to a communication system 100 and includes the following steps 2201 to 2204.

In step 2201, a network device configures a first identifier for at least one of a type 1 terminal or a type 2 terminal.

Related introductions of the type 1 terminal, the type 2 terminal, and the first information may be obtained with reference to the descriptions of the above embodiments.

In some embodiments, the first identifier may be configured to descramble the first information.

In some examples, the first identifier may be an “RNTI,” a “MsgB-RNTI,” an “RA-RNTI,” etc. The name of the first identifier is not limited thereto.

In some embodiments, the above step that “a network device configures a first identifier of first information for at least one of a type 1 terminal or a type 2 terminal” may include at least one of: a step of configuring a first identifier corresponding to the type 1 terminal for the type 1 terminal; or a step of configuring a first identifier corresponding to the type 2 terminal for the type 2 terminal.

In some examples, the above “first identifier corresponding to the type 1 terminal” may be understood, for example, as an identifier for descrambling “first information needs to be sent to the type 1 terminal”. The above “first identifier corresponding to the type 2 terminal” may be understood, for example, as an identifier for descrambling “first information needs to be sent to the type 2 terminal”.

In some examples, the first identifier corresponding to the type 1 terminal is different from the first identifier corresponding to the type 2 terminal.

In some examples, the above “first identifier corresponding to the type 1 terminal” may be the foregoing indication information corresponding to the type 1 terminal. The “first identifier corresponding to the type 1 terminal” may indicate that first information scrambled or descrambled using the first identifier corresponding to the type 1 terminal has an association relationship with the type 1 terminal. In other words, the first information scrambled or descrambled using the first identifier corresponding to the type 1 terminal is information needs to be sent to the type 1 terminal. In some examples, the above “first identifier corresponding to the type 2 terminal” may be the foregoing indication information corresponding to the type 2 terminal. The “first identifier corresponding to the type 2 terminal” may indicate that first information scrambled or descrambled using the first identifier corresponding to the type 2 terminal has an association relationship with the type 2 terminal. In other words, the first information scrambled or descrambled using the first identifier corresponding to the type 2 terminal is information needs to be sent to the type 2 terminal.

In some embodiments, the network device may configure the first identifier of the first information for at least one of the type 1 terminal or the type 2 terminal via first signaling. A detailed introduction of the first signaling may be obtained with reference to the above description.

In some embodiments, the network device may configure the first identifier for the terminal when the terminal triggers random access, or may configure the first identifier for the terminal before the terminal triggers the random access.

It is to be noted that in some embodiments, the network device may not configure the above first identifier for the terminal. In such case, both the terminal and the network device may determine the first identifier based on a specification in a protocol.

In step 2202, the network device sends the first information.

In some examples, the network device may send the first information to at least one of the type 1 terminal or the type 2 terminal. In some examples, in a case where the first information needs to be sent to the type 1 terminal, the network device may scramble the first information using the first identifier corresponding to the type 1 terminal. In a case where the first information needs to be sent to the type 2 terminal, the network device may scramble the first information using the first identifier corresponding to the type 2 terminal.

In step 2203, at least one of the type 1 terminal or the type 2 terminal determines, based on the first identifier, whether the first information is sent to the terminal itself or whether the first information is sent to a terminal type to which the terminal itself belongs.

In some embodiments, a method for the above step that “at least one of the type 1 terminal or the type 2 terminal determines, based on the first identifier, whether the first information is sent to the terminal itself or whether the first information is sent to a terminal type to which the terminal itself belongs” may include the following steps.

After receiving the first information, the type 1 terminal may first descramble the first information based on the first identifier corresponding to the type 1 terminal. In a case where the descrambling succeeds, it is indicated that the first information is sent to the type 1 terminal. In such case, the type 1 terminal determines that the first information is sent to the type 1 terminal itself or is sent to a terminal type to which the type 1 terminal itself belongs. In a case where the descrambling fails, it is indicated that the first information is not sent to the type 1 terminal. In such case, the type 1 terminal determines that the first information is not sent to the type 1 terminal itself or is not sent to the terminal type to which the type 1 terminal itself belongs. Similarly, after receiving the first information, the type 2 terminal may first descramble the first information based on the first identifier corresponding to the type 2 terminal. In a case where the descrambling succeeds, it is indicated that the first information is sent to the type 2 terminal. In such a case, the type 2 terminal determines that the first information is sent to the type 2 terminal itself or is sent to a terminal type to which the type 2 terminal itself belongs. In a case where the descrambling fails, it is indicated that the first information is not sent to the type 2 terminal. In such a case, the type 2 terminal determines that the first information is not sent to the type 2 terminal itself or is not sent to the terminal type to which the type 2 terminal itself belongs.

In step 2204, in a case where the type 1 terminal or the type 2 terminal determines that the first information is not sent to the terminal itself or is not sent to a terminal type to which the terminal itself belongs, it is determined to perform at least one of the following operations: not reading the first information; not receiving a channel scheduled by the first information; or not reading the channel scheduled by the first information.

The communication method related to the embodiment of the present disclosure may include at least one of steps S2201 to S2204. For example, step S2201 may be implemented as an independent embodiment, step S2202 may be implemented as an independent embodiment, and steps S2201+S2202 may be implemented as an independent embodiment, which is not limited thereto.

In the implementation or embodiment, in a case of no contradiction, the steps may be independent or freely combined, or a sequence of the steps may be changed. Optional implementations or examples may be freely combined, and may be freely combined with any step of other implementations or other embodiments.

FIG. 2C is a schematic diagram of the interaction of a communication method according to an embodiment of the present disclosure. As shown in FIG. 2C, an embodiment of the present disclosure relates to a communication method. The above communication method is applied to a communication system 100 and includes the following steps 2301 to 2304.

In step 2301, a network device configures a reference signal resource for at least one of a type 1 terminal or a type 2 terminal.

Related introductions of the type 1 terminal, the type 2 terminal, and the first information may be obtained with reference to the descriptions of the above embodiments.

In some embodiments, the reference signal resource may be used for a channel estimation of a first channel. The first channel is configured to carry the first information. A related introduction of the first channel may be obtained with reference to descriptions of the above embodiments.

In some embodiments, the above step that “a network device configures a reference signal resource for at least one of a type 1 terminal or a type 2 terminal” may include at least one of: a step of configuring a reference signal resource corresponding to the type 1 terminal for the type 1 terminal; or a step of configuring a reference signal resource corresponding to the type 2 terminal for the type 2 terminal.

In some examples, the above “reference signal resource corresponding to the type 1 terminal” may be understood, for example, as a reference signal resource for an estimation of a first channel of the type 1 terminal. The above “reference signal resource corresponding to the type 2 terminal” may be understood, for example, as a reference signal resource for an estimation of a first channel of the type 2 terminal. In some examples, the reference signal resource corresponding to the type 1 terminal is different from the reference signal resource corresponding to the type 2 terminal.

In some examples, the above “reference signal resource corresponding to the type 1 terminal” may be the foregoing indication information corresponding to the type 1 terminal. The “reference signal resource corresponding to the type 1 terminal” may indicate that first information transmitted using the first channel corresponding to the reference signal resource corresponding to the type 1 terminal has an association relationship with the type 1 terminal. In other words, the first information transmitted using the first channel corresponding to the reference signal resource corresponding to the type 1 terminal is information needs to be sent to the type 1 terminal. In some examples, the above “first channel corresponding to the reference signal resource corresponding to the type 1 terminal” may be understood as, for example, a channel for transmitting a reference signal using the reference signal resource corresponding to the type 1 terminal. In some examples, the above “reference signal resource corresponding to the type 2 terminal” may be the foregoing indication information corresponding to the type 2 terminal. The “reference signal resource corresponding to the type 2 terminal” may indicate that first information transmitted using the first channel corresponding to the reference signal resource corresponding to the type 2 terminal has an association relationship with the type 2 terminal. In other words, the first information transmitted using the first channel corresponding to the reference signal resource corresponding to the type 2 terminal is information needs to be sent to the type 2 terminal. In some examples, the above “first channel corresponding to the reference signal resource corresponding to the type 2 terminal” may be understood as, for example, a channel for transmitting a reference signal using the reference signal resource corresponding to the type 2 terminal.

In some embodiments, the network device may configure the reference signal resource for at least one of the type 1 terminal or the type 2 terminal via first signaling. A detailed introduction of the first signaling may be obtained with reference to the above description.

In some embodiments, the reference signal resource may include at least one of a DMRS time domain position, a DMRS frequency domain position, or a DMRS sequence.

In some embodiments, the network device may configure the reference signal resource for the terminal when the terminal triggers random access, or may configure the reference signal resource for the terminal before the terminal triggers the random access.

It is to be noted that in some embodiments, the network device may not configure the above reference signal resource for the terminal. In such case, both the terminal and the network device may determine the reference signal resource based on a specification in a protocol.

In step 2302, the network device sends the first information.

In some examples, the network device may send the first information to at least one of the type 1 terminal or the type 2 terminal. In some examples, the first information is carried in the first channel. In some examples, when the network device sends the first information through the first channel, a reference signal is also sent through the first channel. The reference signal is used for a channel estimation. In some examples, the reference signal may be a DMRS. In some examples, when the network device sends the first channel, in a case where the first information in the first channel needs to be sent to the type 1 terminal, the network device may send the reference signal through the first channel using the reference signal resource corresponding to the type 1 terminal. In a case where the first information in the first channel needs to be sent to the type 2 terminal, the network device may send the reference signal through the first channel using the reference signal resource corresponding to the type 2 terminal.

In step 2303, at least one of the type 1 terminal or the type 2 terminal determines, based on the reference signal resource, whether the first information is sent to the terminal itself or whether the first information is sent to a terminal type to which the terminal itself belongs.

In some embodiments, a method for the above step that “at least one of the type 1 terminal or the type 2 terminal determines, based on the reference signal resource, whether the first information is sent to the terminal itself or whether the first information is sent to a terminal type to which the terminal itself belongs” may include the following steps.

After receiving the first information, the type 1 terminal may first determine a reference signal sequence or extract a signal from the first channel based on the reference signal resource corresponding to the type 1 terminal, and determine whether a correlation peak can be generated between the reference signal sequence or the extracted signal and an original reference signal sequence. In a case where the correlation peak is generated, it is determined that the first information is sent to the type 1 terminal, and in such case, the type 1 terminal determines that the first information is sent to the type 1 terminal itself or is sent to a terminal type to which the type 1 terminal itself belongs. In a case where no correlation peak is generated, it is determined that the first information is not sent to the type 1 terminal, and in such case, the type 1 terminal determines that the first information is not sent to the type 1 terminal itself or is not sent to the terminal type to which the type 1 terminal itself belongs. Similarly, after receiving the first information, the type 2 terminal may first determine a reference signal sequence or extract a signal from the first channel based on the reference signal resource corresponding to the type 2 terminal, and determine whether a correlation peak can be generated between the reference signal sequence or the extracted signal and an original reference signal sequence. In a case where the correlation peak is generated, it is determined that the first information is sent to the type 2 terminal, and in such case, the type 2 terminal determines that the first information is sent to the type 2 terminal itself or is sent to a terminal type to which the type 2 terminal itself belongs. In a case where no correlation peak is generated, it is determined that the first information is not sent to the type 2 terminal, and in such case, the type 2 terminal determines that the first information is not sent to the type 2 terminal itself or is not sent to the terminal type to which the type 2 terminal itself belongs.

In step 2304, in a case where the type 1 terminal or the type 2 terminal determines that the first information is not sent to the terminal itself or is not sent to a terminal type to which the terminal itself belongs, it is determined to perform at least one of the following operations: not reading the first information; not receiving a channel scheduled by the first information; or not reading the channel scheduled by the first information.

The communication method related to the embodiment of the present disclosure may include at least one of steps S2301 to S2304. For example, step S2301 may be implemented as an independent embodiment, step S2302 may be implemented as an independent embodiment, and steps S2301+S2302 may be implemented as an independent embodiment, which is not limited thereto.

In the implementation or embodiment, in a case of no contradiction, the steps may be independent or freely combined, or a sequence of the steps may be changed. Optional implementations or examples may be freely combined, and may be freely combined with any step of other implementations or other embodiments.

FIG. 2D is a schematic diagram of the interaction of a communication method according to an embodiment of the present disclosure. As shown in FIG. 2D, an embodiment of the present disclosure relates to a communication method. The above communication method is applied to a communication system 100 and includes the following steps 2401 to 2403.

In step 2401, a network device sends the first information to at least one of a type 1 terminal or a type 2 terminal.

Related introductions of the type 1 terminal, the type 2 terminal, and the first information may be obtained with reference to the descriptions of the above embodiments.

In some embodiments, a first indication may be carried in the first information. The first indication may be configured to indicate that the first information is sent to the type 1 terminal or the type 2 terminal. In some examples, the first indication may be a bit value. In a case where the first indication is a first value (such as 1), it indicates that the first information is sent to the type 1 terminal. In a case where the first indication is a second value (such as 0), it indicates that the first information is sent to the type 2 terminal.

In some embodiments, the above “first indication in the first information” may be the foregoing indication information. In some examples, in a case where the first indication is configured to indicate that the first information is sent to the type 1 terminal, it indicates that the first information has an association relationship with the type 1 terminal. In a case where the first indication is configured to indicate that the first information is sent to the type 2 terminal, it indicates that the first information has an association relationship with the type 2 terminal.

In some embodiments, the first indication may be carried in at least one of a reserved bit, a newly-added bit, or an original bit (or referred to as an existing bit) of the first information. In step 2402, the type 1 terminal or the type 2 terminal determines, based on the first indication in the first information, whether the first information is sent to the terminal itself or whether the first information is sent to a terminal type to which the terminal itself belongs.

In some embodiments, a method for the above step that “the type 1 terminal or the type 2 terminal determines, based on the first indication in the first information, whether the first information is sent to the terminal itself or whether the first information is sent to a terminal type to which the terminal itself belongs” may include the following steps.

After receiving the first information, in a case where the first indication in the first information is configured to indicate that the first information is sent to the type 1 terminal, the type 1 terminal determines that the first information is sent to the type 1 terminal itself or is sent to a type terminal to which the type 1 terminal itself belongs. In a case where the first indication in the first information is configured to indicate that the first information is sent to the type 2 terminal, the type 1 terminal determines that the first information is not sent to the type 1 terminal itself or is not sent to the terminal type to which the type 1 terminal itself belongs. Similarly, after receiving the first information, in a case where the first indication in the first information is configured to indicate that the first information is sent to the type 1 terminal, the type 2 terminal determines that the first information is not sent to the type 2 terminal itself or is not sent to the terminal type to which the type 2 terminal itself belongs. In a case where the first indication in the first information is configured to indicate that the first information is sent to the type 2 terminal, the type 2 terminal determines that the first information is sent to the type 2 terminal itself or is sent to the terminal type to which the type 2 terminal itself belongs.

In step 2403, in a case where the type 1 terminal or the type 2 terminal determines that the first information is not sent to the terminal itself or is not sent to a terminal type to which the terminal itself belongs, it is determined to perform at least one of the following operations: not reading the first information; not receiving a channel scheduled by the first information; or not reading the channel scheduled by the first information.

The communication method related to the embodiment of the present disclosure may include at least one of steps S2401 to S2403. For example, step S2401 may be implemented as an independent embodiment, step S2402 may be implemented as an independent embodiment, and steps S2401+S2402 may be implemented as an independent embodiment, which is not limited thereto.

In the implementation or embodiment, in a case of no contradiction, the steps may be independent or freely combined, or a sequence of the steps may be changed. Optional implementations or examples may be freely combined, and may be freely combined with any step of other implementations or other embodiments.

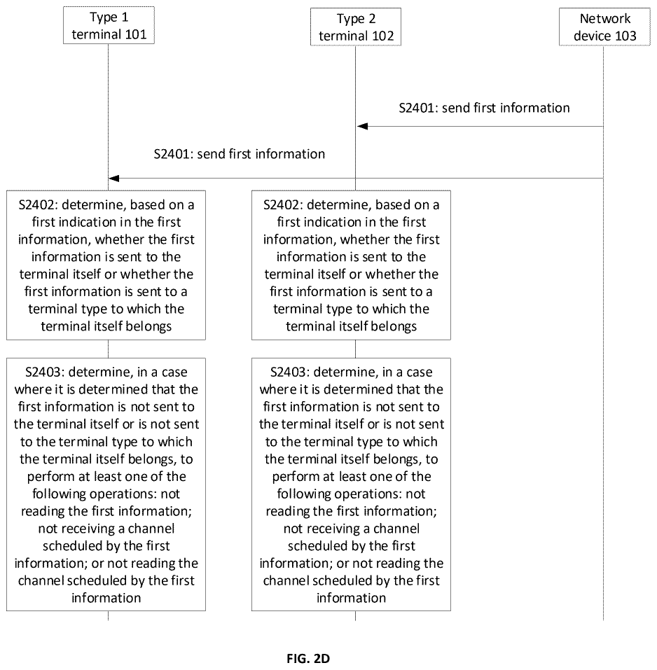

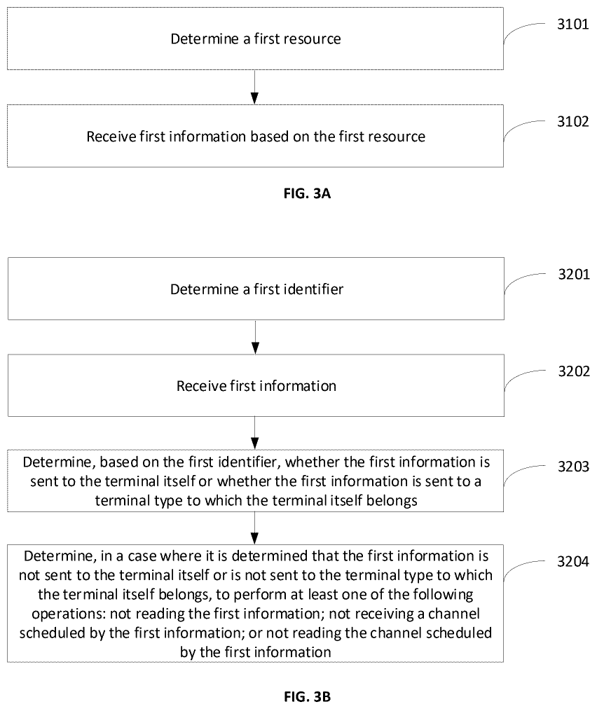

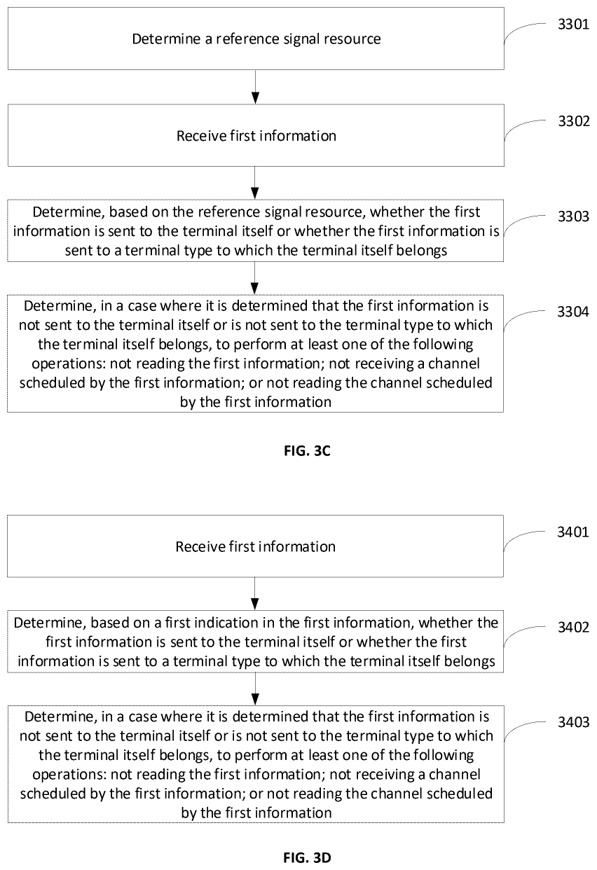

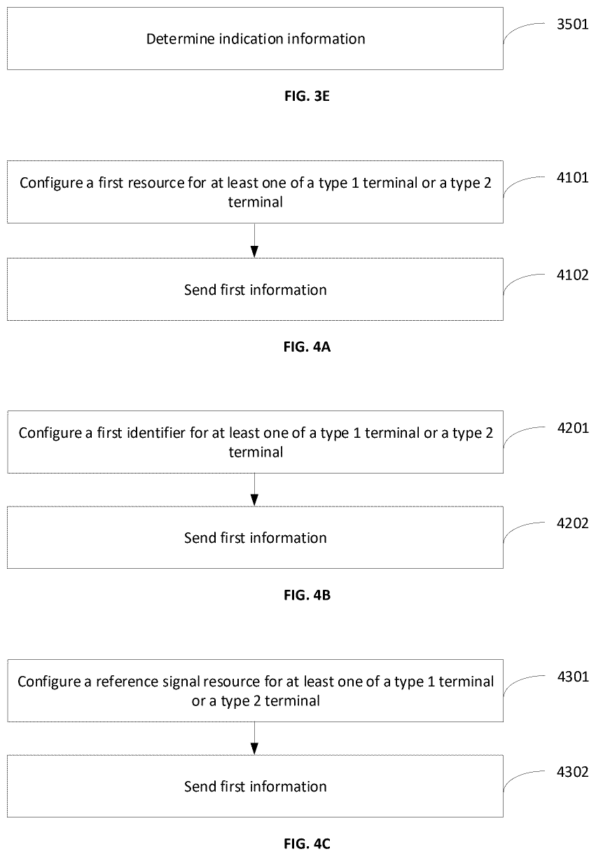

FIG. 3A is a schematic diagram of interaction of a communication method according to an embodiment of the present disclosure. As shown in FIG. 3A, an embodiment of the present disclosure relates to a communication method. The above communication method is applied to a type 1 terminal 101 or a type 2 terminal 102, and includes the following steps 3101 and 3102.

In step 3101, a first resource is determined.

Related introductions of first information and the first resource may be obtained with reference to the descriptions of the above embodiments.

In some embodiments, the above step that “a first resource is determined” may include at least one of: a step of obtaining the first resource configured by a network device; or a step of determining the first resource based on a specification in a protocol.

A related introduction of a step that “a network device configures a first resource” may be obtained with reference to the descriptions of the above embodiments.

In some embodiments, the above step that “a first resource is determined” may include at least one of the following steps.

In a case where a terminal is the type 1 terminal, a first resource corresponding to the type 1 terminal is determined based on at least one of the specification in the protocol or configuration of the network device.

In a case where the terminal is the type 2 terminal, a first resource corresponding to the type 2 terminal is determined based on at least one of: the specification in the protocol or the configuration of the network device.

In some examples, the first resource corresponding to the type 1 terminal is different from the first resource corresponding to the type 2 terminal.

In some other embodiments, the above step that “a first resource is determined” may include the following steps.

In a case where the terminal is the type 1 terminal, the first resource corresponding to the type 2 terminal is determined based on at least one of: the specification in the protocol or the configuration of the network device.

A first offset is determined based on at least one of: the specification in the protocol or the configuration of the network device.

The first resource corresponding to the type 1 terminal is determined based on the first offset and the first resource corresponding to the type 2 terminal.

In some other embodiments, the above step that “a first resource is determined” may include the following steps.

In a case where the terminal is the type 2 terminal, the first resource corresponding to the type 1 terminal is determined based on at least one of: the specification in the protocol or the configuration of the network device.

A second offset is determined based on at least one of: the specification in the protocol or the configuration of the network device.

The first resource corresponding to the type 2 terminal is determined based on the second offset and the first resource corresponding to the type 1 terminal.

Related introductions of “the first offset,” “the second offset,” etc. may be obtained with reference to the descriptions of the above embodiments.

In some embodiments, the terminal may determine the first resource when random access is triggered, or may determine the first resource before the random access is triggered.

Alternatively, a trigger reason of random access information may be taken as a trigger reason for the terminal to determine the first resource.

In step 3102, first information is received based on the first resource.

In some embodiments, in a case where the terminal is the type 1 terminal, the first information may be received based on the first resource corresponding to the type 1 terminal. In a case where the terminal is the type 2 terminal, the first information may be received based on the first resource corresponding to the type 2 terminal.

Detailed introductions of steps 3101 and 3102 may be obtained with reference to the descriptions of the above embodiments.

The communication method related to the embodiment of the present disclosure may include at least one of steps S3101 or S3102. For example, step S3101 may be implemented as an independent embodiment, step S3102 may be implemented as an independent embodiment, and steps S3101+S3102 may be implemented as an independent embodiment, which is not limited thereto.

In the implementation or embodiment, in a case of no contradiction, the steps may be independent or freely combined, or a sequence of the steps may be changed. Optional implementations or examples may be freely combined, and may be freely combined with any step of other implementations or other embodiments.

FIG. 3B is a schematic diagram of the interaction of a communication method according to an embodiment of the present disclosure. As shown in FIG. 3B, an embodiment of the present disclosure relates to a communication method. The above communication method is applied to a type 1 terminal 101 or a type 2 terminal 102, and includes the following steps 3201 to 3204.

In step 3201, a first identifier is determined.

Related introductions of first information and the first identifier of the first information may be obtained with reference to the descriptions of the above embodiments.

In some embodiments, the above step that “a first identifier of first information is determined” may include at least one of: a step of obtaining the first identifier configured by a network device; or a step of determining the first identifier based on a specification in a protocol.

In some embodiments, the above step that “a first identifier is determined” may include at least one of the following steps.

In a case where a terminal is the type 1 terminal, a first identifier corresponding to the type 1 terminal is determined based on at least one of: the specification in the protocol or configuration of the network device.

In a case where the terminal is the type 2 terminal, a first identifier corresponding to the type 2 terminal is determined based on at least one of: the specification in the protocol or the configuration of the network device.

In some embodiments, the first identifier corresponding to the type 1 terminal is different from the first identifier corresponding to the type 2 terminal.

In some embodiments, the terminal may determine the first identifier when random access is triggered, or may determine the first identifier before the random access is triggered.

Alternatively, a trigger reason of random access information may be taken as a trigger reason for the terminal to determine the first identifier.

In step 3202, the first information is received.

In step 3203, whether the first information is sent to the terminal itself or whether the first information is sent to a terminal type to which the terminal itself belongs is determined based on the first identifier.

In step 3204, in a case where it is determined that the first information is not sent to the terminal itself or is not sent to the terminal type to which the terminal itself belongs, it is determined to perform at least one of the following operations: not reading the first information; not receiving a channel scheduled by the first information; or not reading the channel scheduled by the first information.

Detailed introductions of steps 3201 to 3204 may be obtained with reference to the descriptions of the above embodiments.

The communication method related to the embodiment of the present disclosure may include at least one of steps S3201 to S3204. For example, step S3201 may be implemented as an independent embodiment, step S3202 may be implemented as an independent embodiment, and steps S3201+S3202 may be implemented as an independent embodiment, which is not limited thereto.

In the implementation or embodiment, in a case of no contradiction, the steps may be independent or freely combined, or a sequence of the steps may be changed. Optional implementations or examples may be freely combined, and may be freely combined with any step of other implementations or other embodiments.

FIG. 3C is a schematic diagram of interaction of a communication method according to an embodiment of the present disclosure. As shown in FIG. 3C, an embodiment of the present disclosure relates to a communication method. The above communication method is applied to a type 1 terminal 101 or a type 2 terminal 102, and includes the following steps 3301 to 3304.

In step 3301, a reference signal resource is determined.

Related introductions of first information and the reference signal resource may be obtained with reference to the descriptions of the above embodiments.

In some embodiments, the above step that “a reference signal resource is determined” may include at least one of: a step of obtaining the reference signal resource configured by a network device; or a step of determining the reference signal resource based on a specification in a protocol.

In some embodiments, the above step that “a reference signal resource is determined” may include at least one of the following steps.

In a case where a terminal is the type 1 terminal, a reference signal resource corresponding to the type 1 terminal is determined based on at least one of: the specification in the protocol or configuration of the network device.

In a case where the terminal is the type 2 terminal, a reference signal resource corresponding to the type 2 terminal is determined based on at least one of: the specification in the protocol or the configuration of the network device.

In some embodiments, the reference signal resource corresponding to the type 1 terminal is different from the reference signal resource corresponding to the type 2 terminal.

In some embodiments, the terminal may determine the reference signal resource when random access is triggered, or may determine the reference signal resource before the random access is triggered. Alternatively, a trigger reason of random access information may be taken as a trigger reason for the terminal to determine the reference signal resource.

In step 3302, the first information is received.

In step 3303, whether the first information is sent to the terminal itself or whether the first information is sent to a terminal type to which the terminal itself belongs is determined based on the reference signal resource.

In step 3304, in a case where it is determined that the first information is not sent to the terminal itself or is not sent to the terminal type to which the terminal itself belongs, it is determined to perform at least one of the following operations: not reading the first information; not receiving a channel scheduled by the first information; or not reading the channel scheduled by the first information.

Detailed introductions of steps 3301 to 3304 may be obtained with reference to the descriptions of the above embodiments.

The communication method related to the embodiment of the present disclosure may include at least one of steps S3301 to S3304. For example, step S3301 may be implemented as an independent embodiment, step S3302 may be implemented as an independent embodiment, and steps S3301+S3302 may be implemented as an independent embodiment, which is not limited thereto.

In the implementation or embodiment, in a case of no contradiction, the steps may be independent or freely combined, or a sequence of the steps may be changed. Optional implementations or examples may be freely combined, and may be freely combined with any step of other implementations or other embodiments.

FIG. 3D is a schematic diagram of the interaction of a communication method according to an embodiment of the present disclosure. As shown in FIG. 3D, an embodiment of the present disclosure relates to a communication method. The above communication method is applied to a type 1 terminal 101 or a type 2 terminal 102, and includes the following steps 3401 to 3403.

In step 3401, the first information is received.

Regarding the first information, reference may be made to the descriptions of the above embodiments.

In some embodiments, a first indication is carried in the first information. The first indication is configured to indicate that the first information is sent to the type 1 terminal or the type 2 terminal. A related introduction of the first indication may be obtained with reference to the descriptions of the above embodiments.

In step 3402, whether the first information is sent to the terminal itself or whether the first information is sent to a terminal type to which the terminal itself belongs is determined based on the first indication in the first information.

In step 3403, in a case where it is determined that the first information is not sent to the terminal itself or is not sent to the terminal type to which the terminal itself belongs, it is determined to perform at least one of the following operations: not reading the first information; not receiving a channel scheduled by the first information; or not reading the channel scheduled by the first information.

Detailed introductions of steps 3401 to 3403 may be obtained with reference to the descriptions of the above embodiments.

The communication method related to the embodiment of the present disclosure may include at least one of steps S3401 to S3403. For example, step S3401 may be implemented as an independent embodiment, step S3402 may be implemented as an independent embodiment, and steps S3401+S3402 may be implemented as an independent embodiment, which is not limited thereto.

In the implementation or embodiment, in a case of no contradiction, the steps may be independent or freely combined, or a sequence of the steps may be changed. Optional implementations or examples may be freely combined, and may be freely combined with any step of other implementations or other embodiments.

FIG. 3E is a schematic diagram of the interaction of a communication method according to an embodiment of the present disclosure. As shown in FIG. 3E, an embodiment of the present disclosure relates to a communication method. The above communication method is applied to a type 1 terminal 101 or a type 2 terminal 102, and includes the following step 3501.

In step 3501, indication information is determined.

In some embodiments, the indication information is configured to indicate at least one of an association relationship between first information and a terminal type, or an association relationship between the first information and a terminal. The indication information is used by the terminal to determine whether the first information is sent to the terminal itself or whether the first information is sent to a terminal type to which the terminal itself belongs. The first information is configured to schedule a downlink channel.

In some embodiments, the terminal type includes at least one of a type 1 terminal or a type 2 terminal. A capability of the type 1 terminal is different from a capability of the type 2 terminal.

In some embodiments, the indication information may be at least one of the first resource, the first identifier, the reference signal resource, or the first indication mentioned above. In some examples, the step where the indication information is determined includes at least one of the following steps.

A first resource is determined, where the first resource is configured to transmit the first information, and a first resource corresponding to the type 1 terminal is different from a first resource corresponding to the type 2 terminal.

A first identifier is determined, where the first identifier is configured to descramble the first information, and a first identifier corresponding to the type 1 terminal is different from a first identifier corresponding to the type 2 terminal.

A reference signal resource is determined, where the reference signal resource is used for a channel estimation of a first channel, the first channel is configured to carry the first information, and a reference signal resource corresponding to the type 1 terminal is different from a reference signal resource corresponding to the type 2 terminal.

A first indication carried in received first information is determined, where the first indication is configured to indicate that the first information is sent to the type 1 terminal or the type 2 terminal.

In some embodiments, the first information is configured to schedule a second channel, and the second channel is configured to carry a MsgB or a Msg2.

In some embodiments, the first channel is a PDCCH, the second channel is a PDSCH, and the first information is DCI.

It is to be noted that in some embodiments, the terminal may determine the indication information when random access is triggered, or may determine the indication information before the random access is triggered. Alternatively, a trigger reason of random access information may be taken as a trigger reason for the terminal to determine the indication information.

In some embodiments, the first resource includes at least one of a BWP for transmitting the first information, a frequency domain resource corresponding to the first information, or a time domain resource corresponding to the first information.

In some embodiments, the frequency domain resource includes a CORESET. The time domain resource includes at least one of a search space or a PMO.

In some embodiments, the first identifier is an RNTI.

In some embodiments, the reference signal resource includes at least one of a DMRS time domain position, a DMRS frequency domain position, or a DMRS sequence.

In some embodiments, the step of determining the first resource includes at least one of: a step of obtaining the first resource configured by a network device; or a step of determining the first resource based on a specification in a protocol.

The step of determining the first identifier of the first information includes at least one of the following steps.

The first identifier configured by the network device is obtained.

The first identifier is determined based on the specification in the protocol.

The step of determining the reference signal resource corresponding to the first information includes at least one of the following steps.

The reference signal resource configured by the network device is obtained.

The reference signal resource is determined based on the specification in the protocol.

In some embodiments, the step of determining the first resource includes at least one of the following steps.

In a case where the terminal is the type 1 terminal, a first resource corresponding to the type 1 terminal is determined based on at least one of: the specification in the protocol or configuration of the network device.

In a case where the terminal is the type 2 terminal, a first resource corresponding to the type 2 terminal is determined based on at least one of: the specification in the protocol or the configuration of the network device.

Alternatively, the step of determining the first resource includes the following steps.

In a case where the terminal is the type 1 terminal, the first resource corresponding to the type 2 terminal is determined based on at least one of: the specification in the protocol or the configuration of the network device.

A first offset is determined based on at least one of: the specification in the protocol or the configuration of the network device.

The first resource corresponding to the type 1 terminal is determined based on the first offset and the first resource corresponding to the type 2 terminal.

Alternatively, the step of determining the first resource includes the following steps.

In a case where the terminal is the type 2 terminal, the first resource corresponding to the type 1 terminal is determined based on at least one of: the specification in the protocol or the configuration of the network device.

A second offset is determined based on at least one of: the specification in the protocol or the configuration of the network device.

The first resource corresponding to the type 2 terminal is determined based on the second offset and the first resource corresponding to the type 1 terminal.

In some embodiments, after the first resource is determined, the method further includes the following steps.

In a case where the terminal is the type 1 terminal, the first information is received based on the first resource corresponding to the type 1 terminal.

In a case where the terminal is the type 2 terminal, the first information is received based on the first resource corresponding to the type 2 terminal.

In some embodiments, the first indication is carried in at least one of a reserved bit, a newly-added bit, or an original bit of the first information.

In some embodiments, the capability of the type 1 terminal is higher than the capability of the type 2 terminal, or the capability of the type 2 terminal is higher than the capability of the type 1 terminal.

In some embodiments, the type 1 terminal is a non-eRedCap terminal, and the type 2 terminal is an eRedCap terminal; or the type 1 terminal is an eRedCap terminal, and the type 2 terminal is a non-eRedCap terminal.

In some embodiments, the method further includes the following steps.

It is determined, based on the indication information, whether the first information is sent to the terminal itself or whether the first information is sent to a terminal type to which the terminal itself belongs.

In a case where it is determined that the first information is not sent to the terminal itself or is not sent to the terminal type to which the terminal itself belongs, it is determined to perform at least one of the following operations: not reading the first information; not receiving a channel scheduled by the first information; or not reading the channel scheduled by the first information.

An introduction of step 3501 may be obtained with reference to the detailed introductions of FIG. 2A to FIG. 2D and FIG. 3A to FIG. 3D.

In the implementation or embodiment, in a case of no contradiction, the steps may be independent or freely combined, or a sequence of the steps may be changed. Optional implementations or examples may be freely combined, and may be freely combined with any step of other implementations or other embodiments.

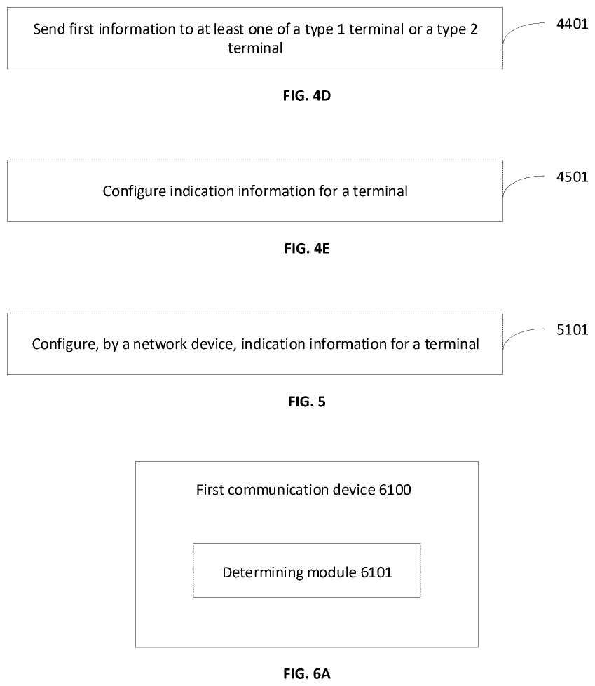

FIG. 4A is a schematic diagram of the interaction of a communication method according to an embodiment of the present disclosure. As shown in FIG. 4A, an embodiment of the present disclosure relates to a communication method. The above communication method is applied to a network device 103 and includes the following steps 4101 and 4102.

In step 4101, a first resource is configured for at least one of a type 1 terminal or a type 2 terminal.

In step 4102, the first information is sent.

Related introductions of steps 4101 and 4102 may be obtained with reference to the descriptions of the above embodiments.

The communication method related to the embodiment of the present disclosure may include at least one of steps S4101 or S4102. For example, step S4101 may be implemented as an independent embodiment, step S4102 may be implemented as an independent embodiment, and steps S4101+S4102 may be implemented as an independent embodiment, which is not limited thereto.

In the implementation or embodiment, in a case of no contradiction, the steps may be independent or freely combined, or a sequence of the steps may be changed. Optional implementations or examples may be freely combined, and may be freely combined with any step of other implementations or other embodiments.

FIG. 4B is a schematic diagram of the interaction of a communication method according to an embodiment of the present disclosure. As shown in FIG. 4B, an embodiment of the present disclosure, relates to a communication method. The above communication method is applied to a network device 103 and includes the following steps 4201 and 4202.

In step 4201, a first identifier is configured for at least one of a type 1 terminal or a type 2 terminal.

In step 4202, first information is sent.

Related introductions of steps 4201 and 4202 may be obtained with reference to the descriptions of the above embodiments.

The communication method related to the embodiment of the present disclosure may include at least one of steps S4201 or S4202. For example, step S4201 may be implemented as an independent embodiment, step S4202 may be implemented as an independent embodiment, and steps S4201+S4202 may be implemented as an independent embodiment, which is not limited thereto.

In the implementation or embodiment, in a case of no contradiction, the steps may be independent or freely combined, or a sequence of the steps may be changed. Optional implementations or examples may be freely combined, and may be freely combined with any step of other implementations or other embodiments.

FIG. 4C is a schematic diagram of the interaction of a communication method according to an embodiment of the present disclosure. As shown in FIG. 4C, an embodiment of the present disclosure relates to a communication method. The above communication method is applied to a network device 103 and includes the following steps 4301 and 4302.

In step 4301, a reference signal resource is configured for at least one of a type 1 terminal or a type 2 terminal.

In step 4302, the first information is sent.

Related introductions of steps 4301 and 4302 may be obtained with reference to the descriptions of the above embodiments.

The communication method related to the embodiment of the present disclosure may include at least one of steps S4301 or S4302. For example, step S4301 may be implemented as an independent embodiment, step S4302 may be implemented as an independent embodiment, and steps S4301+S4302 may be implemented as an independent embodiment, which is not limited thereto.

In the implementation or embodiment, in a case of no contradiction, the steps may be independent or freely combined, or a sequence of the steps may be changed. Optional implementations or examples may be freely combined, and may be freely combined with any step of other implementations or other embodiments.

FIG. 4D is a schematic diagram of interaction of a communication method according to an embodiment of the present disclosure. As shown in FIG. 4D, an embodiment of the present disclosure relates to a communication method. The above communication method is applied to a network device 103 and includes the following step 4401.

In step 4401, the first information is sent to at least one of a type 1 terminal or a type 2 terminal.

A related introduction of step 4401 may be obtained with reference to the descriptions of the above embodiments.

In the implementation or embodiment, in a case of no contradiction, the steps may be independent or freely combined, or a sequence of the steps may be changed. Optional implementations or examples may be freely combined, and may be freely combined with any step of other implementations or other embodiments.

FIG. 4E is a schematic diagram of the interaction of a communication method according to an embodiment of the present disclosure. As shown in FIG. 4E, an embodiment of the present disclosure, relates to a communication method. The above communication method is applied to a network device 103 and includes the following step 4501.

In step 4501, indication information is configured for a terminal.

In some embodiments, the indication information is configured to indicate at least one of an association relationship between first information and a terminal type, or an association relationship between the first information and the terminal. The indication information is used by the terminal to determine whether the first information is sent to the terminal itself or whether the first information is sent to a terminal type to which the terminal itself belongs. A capability of a type 1 terminal is different from a capability of a type 2 terminal. The first information is configured to schedule a downlink channel.

In some embodiments, the terminal type includes at least one of the type 1 terminal or the type 2 terminal. The capability of the type 1 terminal is different from the capability of the type 2 terminal.

In some embodiments, the indication information may be at least one of the first resource, the first identifier, the reference signal resource, or the first indication mentioned above. In some examples, the step for which the indication information is configured for at least one of the type 1 terminal or the type 2 terminal includes at least one of the following steps.

A first resource is configured for at least one of the type 1 terminal or the type 2 terminal, where the first resource is configured to transmit the first information, and a first resource corresponding to the type 1 terminal is different from a first resource corresponding to the type 2 terminal.

A first identifier is configured for at least one of the type 1 terminal or the type 2 terminal, where the first identifier is configured to descramble the first information, and a first identifier corresponding to the type 1 terminal is different from a first identifier corresponding to the type 2 terminal.

A reference signal resource is configured for at least one of the type 1 terminal or the type 2 terminal, where the reference signal resource is used for a channel estimation of a first channel, the first channel is configured to carry the first information, and a reference signal resource corresponding to the type 1 terminal is different from a reference signal resource corresponding to the type 2 terminal.

The first information carrying a first indication is sent to at least one of the type 1 terminal or the type 2 terminal, where the first indication is configured to indicate that the first information is sent to the type 1 terminal or the type 2 terminal.

The first information is configured to schedule a second channel, and the second channel is configured to carry a MsgB or a Msg2.

In some embodiments, the first channel is a PDCCH, the second channel is a PDSCH, and the first information is DCI.

It is to be noted that in some embodiments, the network device may configure the indication information for the terminal when the terminal triggers random access, or may configure the indication information for the terminal before the terminal triggers the random access.

In some embodiments, the first resource includes at least one of a BWP for transmitting the first information, a frequency domain resource corresponding to the first information, or a time domain resource corresponding to the first information. In some embodiments, the frequency domain resource includes a CORESET. The time domain resource includes at least one of a search space or a PMO. In some embodiments, the first identifier is an RNTI. In some embodiments, the reference signal resource includes at least one of a DMRS time domain position, a DMRS frequency domain position, or a DMRS sequence.

In some embodiments, the step of configuring the first resource includes at least one of the following steps.

The first resource corresponding to the type 1 terminal is configured for the type 1 terminal. The first resource corresponding to the type 2 terminal is configured for the type 2 terminal. Alternatively, the step of configuring the first resource includes the following steps.

The first resource corresponding to the type 2 terminal is configured for the type 1 terminal and the type 2 terminal.

A first offset is configured for the type 1 terminal, where the first offset is configured to determine the first resource corresponding to the type 1 terminal.

Alternatively, the step of configuring the first resource includes the following steps.

The first resource corresponding to the type 1 terminal is configured for the type 1 terminal and the type 2 terminal.

A second offset is configured for the type 2 terminal, where the second offset is configured to determine the first resource corresponding to the type 2 terminal.

In some embodiments, after the first resource is configured, the method further includes the following steps.

The first information is sent to the type 1 terminal based on the first resource corresponding to the type 1 terminal.

The first information is sent to the type 2 terminal based on the first resource corresponding to the type 2 terminal.

In some embodiments, the first indication is carried in at least one of a reserved bit, a newly-added bit, or an original bit of the first information.

In some embodiments, the capability of the type 1 terminal is higher than the capability of the type 2 terminal, or the capability of the type 2 terminal is higher than the capability of the type 1 terminal.

In some embodiments, the type 1 terminal is a non-eRedCap terminal, and the type 2 terminal is an eRedCap terminal; or the type 1 terminal is an eRedCap terminal, and the type 2 terminal is a non-eRedCap terminal.

In the implementation or embodiment, in a case of no contradiction, the steps may be independent or freely combined, or a sequence of the steps may be changed. Optional implementations or examples may be freely combined, and may be freely combined with any step of other implementations or other embodiments.

FIG. 5 is a schematic flowchart of a communication method according to an embodiment of the present disclosure. As shown in FIG. 5, an embodiment of the present disclosure relates to a communication method. The above communication method is applied to a communication system and includes the following step 5101.

In step 5101, a network device configures indication information for a terminal.

In some embodiments, the indication information is configured to indicate at least one of an association relationship between first information and a terminal type, or an association relationship between the first information and the terminal. The indication information is used by the terminal to determine whether the first information is sent to the terminal itself or whether the first information is sent to a terminal type to which the terminal itself belongs. The first information is configured to schedule a downlink channel.

A related introduction of step 5101 may be obtained with reference to the descriptions of the above embodiments.

In the implementation or embodiment, in a case of no contradiction, the steps may be independent or freely combined, or a sequence of the steps may be changed. Optional implementations or examples may be freely combined, and may be freely combined with any step of other implementations or other embodiments.

The following is an illustrative introduction of the above method.

Considering using at least one of the following optional modes, unnecessary DCI blind detection or DCI reading is prevented from being introduced into a non-eRedCap terminal and a eRedCap terminal while a MsgB PDSCH of the eRedCap terminal and a MsgB PDSCH of the non-eRedCap terminal are scheduled separately.

Optional mode 1: a separate initial BWP is configured for a Rel-18 RedCap terminal, such that the Rel-18 RedCap terminal is distinguished from the non-eRedCap terminal.

Optional mode 2: a separate CORESET is configured, so as to be distinguished from a PDCCH (frequency domain) resource of the non-eRedCap.

Optional mode 3: CORESET configuration is performed via separate RRC signaling, or a segment of frequency domain offset is configured/specified in a protocol.

Optional mode 4: a separate RACH search space or a separate PDCCH monitoring occasion is configured, so as to be distinguished from a PDCCH (time domain) resource of the non-eRedCap. A possible mode for configuring a separate PMO of the Rel-18 RedCap terminal is to set a time domain offset corresponding to a PMO of a legacy type 1 CSS.

Optional mode 5: the Rel-18 RedCap terminal determines a separate MsgB-RNTI based on the protocol, such that excessive reading of DCI by two different types of terminals is reduced.

Option mode 6: a separate DMRS resource (at least one of time/frequency/sequence, etc.) is configured for the Rel-18 RedCap terminal, such that unnecessary decoding and DCI reading of the PDCCH by the terminal are avoided.

Option mode 7: 1 bit in the DCI is used for indication. The DCI is DCI of the eRedCap, and a reserved bit, a newly-added bit, and a reused existing bit may be used for indication.

An embodiment of the present disclosure further provides a device configured to implement any one of the above methods. For example, a device is provided, and the above device includes a unit or module configured to implement each step performed by the terminal in any one of the above methods. For another example, another device is further provided, and the above device includes a unit or module configured to implement each step performed by the network device (such as an access network device, a core network functional node, and a core network device) in any one of the above methods.

It is to be understood that the division of the units or modules in the above device is merely a division of logical functions, and may be fully or partially integrated into one physical entity or physically separated during actual implementation. In addition, the units or modules in the device may be implemented in the form of processor-invoked software. For example, the device includes a processor. The processor is connected to a memory, the memory stores instructions, and the processor invokes the instructions stored in the memory to implement any one of the above methods or to implement functions of the units or modules of the above device. The processor is, for example, a general purpose processor, such as a Central Processing Unit (CPU) or a microprocessor. The memory is a memory in the device or a memory outside the device. Alternatively, the units or modules in the device may be implemented in the form of a hardware circuit. Functions of some or all of the units or modules may be implemented by designing the hardware circuit. The above hardware circuit may be understood as one or more processors. For example, in one implementation, the above hardware circuit is an Application-Specific Integrated Circuit (ASIC), and the functions of some or all of the above units or modules are implemented by designing logical relationships of elements in the circuit. For another example, in another implementation, the above hardware circuit may be implemented by a Programmable Logic Device (PLD). Taking a Field Programmable Gate Array (FPGA) as an example, the FPGA may include a large number of logic gate circuits. Connection relationships between the logic gate circuits are configured via configuration files, such that the functions of some or all of the above units or modules are implemented. All units or modules of the above device may be implemented entirely in the form of processor-invoked software, or entirely in the form of a hardware circuit, or partially in the form of processor-invoked software and the remaining in the form of a hardware circuit.

In an embodiment of the present disclosure, the processor is a circuit having a signal processing capability. In an implementation, the processor may be a circuit having an instruction reading and running capability, such as a Central Processing Unit (CPU), a microprocessor, a Graphics Processing Unit (GPU) (which may be understood as a microprocessor), or a Digital Signal Processor (DSP). In another implementation, the processor may implement a function by a logical relationship of a hardware circuit. The logical relationship of the hardware circuit is fixed or reconfigurable. For example, the processor is an Application-Specific Integrated Circuit (ASIC) or a hardware circuit implemented by a Programmable Logic Device (PLD), such as an FPGA. In a reconfigurable hardware circuit, the processor loads a configuration file to achieve a hardware circuit configuration. Such process may be understood as a process of loading instructions by the processor to implement the functions of some or all of the above units or modules. In addition, the processor may further be a hardware circuit designed for artificial intelligence, and may be understood as an ASIC, such as a Neural Network Processing Unit (NPU), a Tensor Processing Unit (TPU), and a Deep learning Processing Unit (DPU).

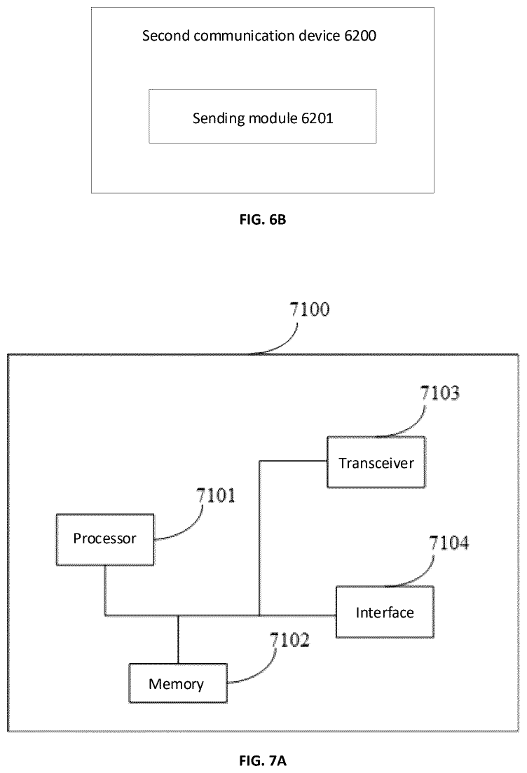

FIG. 6A is a schematic diagram of a structure of a first communication device 6100 according to an embodiment of the present disclosure. As shown in FIG. 6A, the first communication device 6100 includes a determining module 6101 configured to determine indication information. The indication information is configured to indicate at least one of an association relationship between first information and a terminal type, or an association relationship between the first information and a terminal. The first information is configured to schedule a downlink channel. In some examples, the above determining module 6101 is configured to perform the step related to “determining” performed by the type 1 terminal 101 or the type 2 terminal 102 in any one of the above methods, which is not repeated here. In some examples, the first communication device 6100 further includes at least one of a sending module or a receiving module. The above receiving module is configured to perform the step related to receiving performed by the type 1 terminal 101 or the type 2 terminal 102 in any one of the above methods, and the above sending module is configured to perform the step related to sending performed by the type 1 terminal 101 or the type 2 terminal 102 in any one of the above methods.

FIG. 6B is a schematic diagram of a structure of a second communication device 6200 according to an embodiment of the present disclosure. As shown in FIG. 6B, the second communication device 6200 includes a sending module 6201 configured to configure indication information for a terminal. The indication information is configured to indicate at least one of an association relationship between first information and a terminal type, or an association relationship between the first information and the terminal. The first information is configured to schedule a downlink channel. In some examples, the above sending module 6201 is configured to perform the step related to “sending” performed by the network device 103 in any one of the above methods, which is not repeated here. In some examples, the second communication device 6200 further includes at least one of a determining module or a receiving module. The above determining module is configured to perform the step related to determining performed by the network device 103 in any one of the above methods, and the above receiving module is configured to perform the step related to receiving performed by the network device 103 in any one of the above methods, which is not repeated here.

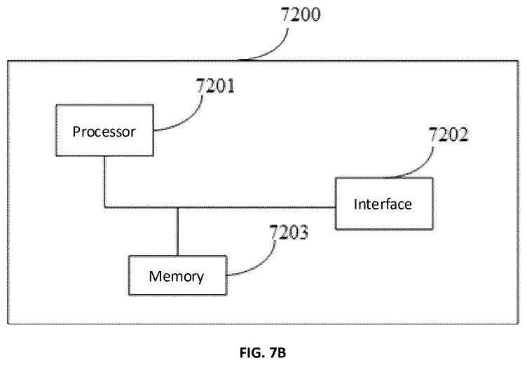

FIG. 7A is a schematic diagram of a structure of a communication device 7100 according to an embodiment of the present disclosure. The communication device 7100 may be a network device (such as an access network device and a core network device), may be a terminal (such as user equipment), may be a chip, a system on chip, or a processor that supports a network device to implement any one of the above methods, or may be a chip, a system on chip, or a processor that supports a terminal to implement any one of the above methods. The communication device 7100 may be configured to implement the method described in the above method embodiments. Details may be obtained with reference to the descriptions in the above method embodiments.

As shown in FIG. 7A, the communication device 7100 includes one or more processors 7101. The processor 7101 may be a general purpose processor or a special purpose processor, such as a baseband processor or a central processing unit. The baseband processor may be configured to process a communication protocol and communication data. The central processing unit may be configured to control a communication device (such as a base station, a baseband chip, a terminal, a terminal chip, a DU, and a CU), execute a program, and process data of the program. The processor 7101 is configured to invoke instructions to enable the communication device 7100 to perform any one of the above methods.

In some embodiments, the communication device 7100 further includes one or more memories 7102 for storing instructions. In some examples, all or some of the memories 7102 may be located outside the communication device 7100.

In some embodiments, the communication device 7100 further includes one or more transceivers 7103. In a case where the communication device 7100 includes one or more transceivers 7103, communication steps such as sending and receiving in the above methods are performed by the transceiver 7103, and other steps are performed by the processor 7101.

In some embodiments, the transceiver may include a receiver and a transmitter. The receiver and the transmitter may be separated or integrated together. In some examples, the terms such as transceiver, transceiver unit, transceiver machine, and transceiver circuit are interchangeable. The terms such as transmitter, transmitter unit, transmitter machine, and transmitter circuit are interchangeable. The terms such as receiver, receiver unit, receiver machine, and receiver circuit are interchangeable.

In some examples, the communication device 7100 further includes one or more interface circuits 7104. The interface circuit 7104 is connected to the memory 7102. The interface circuit 7104 may be configured to receive a signal from the memory 7102 or another device, and may be configured to send a signal to the memory 7102 or another device. For example, the interface circuit 7104 may read instructions stored in the memory 7102 and send the instructions to the processor 7101.

The communication device 7100 in the descriptions of the above embodiments may be a network device or a terminal, but the scope of the communication device 7100 described in the present disclosure is not limited thereto. The structure of the communication device 7100 may not be limited by FIG. 7A. The communication device may be an independent device or may be a part of a large device. For example, the communication device may be (1) an independent integrated circuit (IC), a chip, a system on chip, or a subsystem; (2) a set having one or more ICs, where in some examples, the above IC set may also include a storing component for storing data and a program; (3) an ASIC, such as a Modem; (4) a module capable of being embedded within another device; (5) a receiver, a terminal, an intelligent terminal, a cellular phone, a wireless device, a handset, a mobile unit, an in-vehicle device, a network device, a cloud device, or an artificial intelligence device, etc.; or (6) another device, etc.

FIG. 7B is a schematic diagram of a structure of a chip 7200 according to an embodiment of the present disclosure. For a case where the communication device 7100 may be a chip or a system on chip, reference may be made to the schematic diagram of the structure of the chip 7200 shown in FIG. 7B, but is not limited thereto.

The chip 7200 includes one or more processors 7201. The processor 7201 is configured to invoke instructions to enable the chip 7200 to perform any one of the above methods.

In some embodiments, the chip 7200 further includes one or more interface circuits 7202. The interface circuit 7202 is connected to a memory 7203. The interface circuit 7202 may be configured to receive a signal from the memory 7203 or another device, and may be configured to send a signal to the memory 7203 or another device. For example, the interface circuit 7202 may read instructions stored in the memory 7203 and send the instructions to the processor 7201. In some examples, the terms such as interface circuit, interface, transceiver pin, and transceiver are interchangeable.

In some embodiments, the chip 7200 further includes one or more memories 7203 for storing instructions. In some examples, all or some of the memories 7203 may be located outside the chip 7200.

The present disclosure further provides a storage medium. The above storage medium stores instructions, and the above instructions, when run on the communication device 7100, enable the communication device 7100 to perform any one of the above methods. In some examples, the above storage medium is an electronic storage medium. In some examples, the above storage medium is a computer-readable storage medium, but is not limited thereto, and may also be a storage medium readable by other devices. In some examples, the above storage medium may be a non-transitory storage medium, but is not limited thereto, and may also be a transitory storage medium.

The present disclosure further provides a program product. The above program product, when executed by the communication device 7100, enables the communication device 7100 to perform any one of the above methods. In some examples, the above program product is a computer program product.

The present disclosure further provides a computer program. The above computer program, when run on a computer, enables the computer to perform any one of the above methods.

All or some of the above embodiments may be implemented by software, hardware, firmware, or any combination thereof. In a case where software is used for implementation, implementation may be entirely or partially performed in a form of a computer program product. The computer program product includes one or more computer programs. When the computer program is loaded and executed on a computer, all or some of the flows or functions according to the embodiments of the present disclosure are generated. The computer may be a general-purpose computer, a dedicated computer, a computer network, or another programmable device. The computer program may be stored in a computer-readable storage medium, or may be transmitted from a computer-readable storage medium to another computer-readable storage medium. For example, the computer program may be transmitted from a website, computer, server, or data center to another website, computer, server, or data center in a wired manner (for example, a coaxial cable, an optical fiber, or a digital subscriber line (DSL)) or a wireless manner (for example, infrared rays, radio, or microwave). The computer-readable storage medium may be any available medium that may be accessed by the computer, or a data storage device, such as a server or a data center including one or more available media integrated. The available medium may be a magnetic medium (such as a floppy disk, a hard disk, and a magnetic tape), an optical medium (such as a digital video disc (DVD)), a semiconductor medium (such as a solid state disk (SSD)), etc.

A person of ordinary skill in the art may appreciate that units and algorithm steps of examples described in combination with the embodiments disclosed herein may be implemented by electronic hardware, or a combination of computer software and electronic hardware. Whether the functions are performed by hardware or software depends on a specific application and a design constraint condition of the technical solution. A person skilled in the art may implement the described functions using different methods for each particular application, but such implementation should not be considered as going beyond the scope of the present disclosure.

A person skilled in the art may clearly understand that for convenience and conciseness of description, the specific operating processes of the systems, devices, and units described above may be obtained with reference to the corresponding processes in the above method embodiments, which are not repeated here.

The above are merely specific implementations of the present disclosure, but the scope of protection of the present disclosure is not limited thereto. Any change or substitution that may be readily conceived by a person skilled in the art within the technical scope disclosed by the present disclosure should fall within the scope of protection of the present disclosure. Thus, the scope of protection of the present disclosure should be subject to the scope of protection of the claims.

1. A communication method, performed by a terminal, comprising:
determining indication information, wherein the indication information is configured to indicate at least one of an association relationship between first information and a terminal type, or an association relationship between the first information and the terminal, and the first information is configured to schedule a downlink channel;
wherein the terminal type comprises at least one of a type 1 terminal or a type 2 terminal, and a capability of the type 1 terminal is different from a capability of the type 2 terminal; and
wherein the capability of the type 1 terminal is higher than the capability of the type 2 terminal, or the capability of the type 2 terminal is higher than the capability of the type 1 terminal.

2. (canceled)

3. The communication method according to claim 1, wherein determining the indication information comprises at least one of:
determining a first resource, wherein the first resource is configured to transmit the first information, and a first resource corresponding to the type 1 terminal is different from a first resource corresponding to the type 2 terminal;
determining a first identifier, wherein the first identifier is configured to descramble the first information, and a first identifier corresponding to the type 1 terminal is different from a first identifier corresponding to the type 2 terminal;
determining a reference signal resource, wherein the reference signal resource is used for a channel estimation of a first channel, the first channel is configured to carry the first information, and a reference signal resource corresponding to the type 1 terminal is different from a reference signal resource corresponding to the type 2 terminal; or
determining a first indication carried in received first information, wherein the first indication is configured to indicate that the first information is sent to the type 1 terminal or the type 2 terminal.

4. The communication method according to claim 3, wherein the first information is configured to schedule a second channel, and the second channel is configured to carry a message B (MsgB) or a Msg2.

5. (canceled)

6. The communication method according to claim 3, wherein the first resource comprises at least one of a bandwidth part (BWP) for transmitting the first information, a frequency domain resource corresponding to the first information, or a time domain resource corresponding to the first information.

7. The communication method according to claim 6, wherein the frequency domain resource comprises a control resource set (CORESET), and the time domain resource comprises at least one of a search space or a physical downlink control channel monitoring occasion (PMO).

8. The communication method according to claim 3, wherein the first identifier is a radio network temporary identifier (RNTI).

9. The communication method according to claim 3, wherein the reference signal resource comprises at least one of a demodulation reference signal (DMRS) time domain position, a DMRS frequency domain position, or a DMRS sequence.

10. (canceled)

11. The communication method according to claim 3, wherein determining the first resource comprises at least one of:
determining, in a case where the terminal is the type 1 terminal, the first resource corresponding to the type 1 terminal based on at least one of a specification in a protocol or configuration of a network device; or
determining, in a case where the terminal is the type 2 terminal, the first resource corresponding to the type 2 terminal based on at least one of the specification in the protocol or the configuration of the network device; or
determining the first resource comprises:
determining, in a case where the terminal is the type 1 terminal, the first resource corresponding to the type 2 terminal based on at least one of the specification in the protocol or the configuration of the network device;
determining a first offset based on at least one of the specification in the protocol or the configuration of the network device; and
determining the first resource corresponding to the type 1 terminal based on the first offset and the first resource corresponding to the type 2 terminal; or
determining the first resource comprises:
determining, in a case where the terminal is the type 2 terminal, the first resource corresponding to the type 1 terminal based on at least one of the specification in the protocol or the configuration of the network device;
determining a second offset based on at least one of the specification in the protocol or the configuration of the network device; and
determining the first resource corresponding to the type 2 terminal based on the second offset and the first resource corresponding to the type 1 terminal.

12. The communication method according to claim 3, wherein after determining the first resource, the method further comprises:
receiving, in a case where the terminal is the type 1 terminal, the first information based on the first resource corresponding to the type 1 terminal; and
receiving, in a case where the terminal is the type 2 terminal, the first information based on the first resource corresponding to the type 2 terminal.

13-15. (canceled)

16. The communication method according to claim 1, further comprising:
determining, based on the indication information, whether the first information is sent to the terminal itself or whether the first information is sent to a terminal type to which the terminal itself belongs; and
determining, in a case where it is determined that the first information is not sent to the terminal itself or is not sent to the terminal type to which the terminal itself belongs, to perform at least one of the following operations: not reading the first information; not receiving a channel scheduled by the first information; or not reading the channel scheduled by the first information.

17. A communication method, performed by a network device, comprising:
configuring indication information for a terminal, wherein the indication information is configured to indicate at least one of an association relationship between first information and a terminal type, or an association relationship between the first information and the terminal, and the first information is configured to schedule a downlink channel;
wherein the terminal type comprises at least one of a type 1 terminal or a type 2 terminal, and a capability of the type 1 terminal is different from a capability of the type 2 terminal; and
wherein the capability of the type 1 terminal is higher than the capability of the type 2 terminal, or the capability of the type 2 terminal is higher than the capability of the type 1 terminal.

18. (canceled)

19. The communication method according to claim 17, wherein configuring the indication information for the terminal comprises at least one of:
configuring a first resource for at least one of the type 1 terminal or the type 2 terminal, wherein the first resource is configured to transmit the first information, and a first resource corresponding to the type 1 terminal is different from a first resource corresponding to the type 2 terminal;
configuring a first identifier for at least one of the type 1 terminal or the type 2 terminal, wherein the first identifier is configured to descramble the first information, and a first identifier corresponding to the type 1 terminal is different from a first identifier corresponding to the type 2 terminal;
configuring a reference signal resource for at least one of the type 1 terminal or the type 2 terminal, wherein the reference signal resource is used for a channel estimation of a first channel, the first channel is configured to carry the first information, and a reference signal resource corresponding to the type 1 terminal is different from a reference signal resource corresponding to the type 2 terminal; or
sending the first information carrying a first indication to at least one of the type 1 terminal or the type 2 terminal, wherein the first indication is configured to indicate that the first information is sent to the type 1 terminal or the type 2 terminal.

20. The communication method according to claim 19, wherein the first information is configured to schedule a second channel, and the second channel is configured to carry a message B (MsgB) or a Msg2.

21. (canceled)

22. The communication method according to claim 19, wherein the first resource comprises at least one of a bandwidth part (BWP) for transmitting the first information, a frequency domain resource corresponding to the first information, or a time domain resource corresponding to the first information.

23. The communication method according to claim 22, wherein the frequency domain resource comprises a control resource set (CORESET), and the time domain resource comprises at least one of a search space or a physical downlink control channel monitoring occasion (PMO).

24. The communication method according to claim 19, wherein the first identifier is a radio network temporary identifier (RNTI).

25. The communication method according to claim 19, wherein the reference signal resource comprises at least one of a demodulation reference signal (DMRS) time domain position, a DMRS frequency domain position, or a DMRS sequence.

26. The communication method according to claim 19, wherein configuring the first resource comprises at least one of:
configuring the first resource corresponding to the type 1 terminal for the type 1 terminal; or
configuring the first resource corresponding to the type 2 terminal for the type 2 terminal; or
configuring the first resource comprises:
configuring the first resource corresponding to the type 2 terminal for the type 1 terminal and the type 2 terminal; and
configuring a first offset for the type 1 terminal, wherein the first offset is configured to determine the first resource corresponding to the type 1 terminal; or
configuring the first resource comprises:
configuring the first resource corresponding to the type 1 terminal for the type 1 terminal and the type 2 terminal; and
configuring a second offset for the type 2 terminal, wherein the second offset is configured to determine the first resource corresponding to the type 2 terminal;
wherein after configuring the first resource, the method further comprises:
sending the first information to the type 1 terminal based on the first resource corresponding to the type 1 terminal; and
sending the first information to the type 2 terminal based on the first resource corresponding to the type 2 terminal.

27-36. (canceled)

37. A terminal, comprising a processor and a memory, wherein the memory is configured to store a computer program; and
the processor is configured to execute the computer program to:
determine indication information, wherein the indication information is configured to indicate at least one of an association relationship between first information and a terminal type, or an association relationship between the first information and the terminal, and the first information is configured to schedule a downlink channel;
wherein the terminal type comprises at least one of a type 1 terminal or a type 2 terminal, and a capability of the type 1 terminal is different from a capability of the type 2 terminal; and
wherein the capability of the type 1 terminal is higher than the capability of the type 2 terminal, or the capability of the type 2 terminal is higher than the capability of the type 1 terminal.

38. A network device, comprising a processor and a memory, wherein the memory is configured to store a computer program; and
the processor is configured to execute the computer program to perform the communication method according to claim 17.
